(19) United States
(12) Patent Application Publication
(10) Pub. No.: US 2025/0282160 A1
(43) Pub. Date: Sep. 11, 2025

(54) RECORDING DEVICE

(71) Applicant: CANON KABUSHIKI KAISHA, Tokyo (JP)

(72) Inventors: ITARU WADA, Kanagawa (JP); YUYA NANJI, Kanagawa (JP); RYOSUKE MURATA, Tokyo (JP)

(21) Appl. No.: 19/060,601

(22) Filed: Feb. 21, 2025

(30) Foreign Application Priority Data
Mar. 5, 2024 (JP) 2024-033235

(51) Int. Cl. B41J 25/308; B41J 15/02

(52) U.S. Cl. CPC B41J 25/3082; B41J 15/02

(57) ABSTRACT

A recording device includes: a first fixing member; a first contact portion movable between a first pressing position to press a first shaft hole of a first roll sheet radially outward and a first non-pressing position located on a radially inward side of the first pressing position; a cam moving the first contact portion between the first pressing position and the first non-pressing position; a second fixing member attachable to or detachable from the first fixing member; and a second contact portion movable between a second pressing position to press a second shaft hole of a second roll sheet radially outward and a second non-pressing position located on a radially inward side of the second pressing position. In a state where the second fixing member is attached to the first fixing member, the cam moves the second contact portion between the second pressing position and the second non-pressing position.

### BACKGROUND OF THE INVENTION

### Field of the Invention

The present invention relates to a recording device which performs recording on a sheet supplied from a roll sheet held by a holding device.

### Description of the Related Art

There is a recording device, which includes a holding device holding a roll sheet, which is a sheet rolled around a hollow shaft having a shaft hole, and performs recording on the sheet supplied from the roll sheet held by the holding device. According to a recording device disclosed in Japanese Patent No. 3928705, a roll sheet pressor is attached to the shaft of the roll sheet, the roll sheet held by the roll sheet pressor is attached to a spindle, and the spindle is supported by spindle bearings of the recording device main unit, whereby the roll sheet is set in the recording device. The inner diameter of the shaft hole of the shaft of the roll sheet may be different depending on the roll sheet.

The roll sheet pressor of the recording device according to Japanese Patent No. 3928705 includes a flange of which shaft core corresponding to a small diameter shaft hole protrudes, and an adapter corresponding to a large diameter shaft hole is attached to the shaft core, so as to support roll sheets having different inner diameters of the shaft holes. The shaft core and the adapter have a leaf spring which radially bends, and when the shaft hole of the roll sheet is inserted into the shaft core and the adapter, the shaft of the roll sheet is firmly held by the elastic force generated by the bending of the leaf spring.

In the case of the recording device according to Japanese Patent No. 3928705 however, the shaft core of the roll sheet pressor needs to be attached to/detached from the shaft hole of the roll sheet while bending the leaf spring, hence a force for bending the leaf spring against the elastic force of the leaf spring is required when the roll sheet pressor is attached/detached. Therefore, operability of the attachment/detachment of the roll sheet pressor need to be improved.

### SUMMARY OF THE INVENTION

In the recording device having the holding device which can support roll sheets of which inner diameters of the respective shaft holes are different, the present invention improves operability of the attachment/detachment of the roll sheet to/from the holding device.

The present invention is a recording device, comprising:
a holding device configured to hold a roll sheet that is a sheet rolled around a shaft having a shaft hole; and
a recording unit configured to perform recording on the sheet supplied from the holding device that holds the roll sheet, wherein
the holding device further comprising:
a first fixing member including a first core configured to be inserted into a first shaft hole of a first roll sheet, the first shaft hole having a first inner diameter;
a first contact portion formed of an elastic body disposed in the first fixing member, the first contact portion being configured to move between a first pressing position where the first contact portion contacts an inner peripheral surface of the first shaft hole and presses the inner peripheral surface radially outward and a first non-pressing position located on a radially inward side of the first pressing position;
a cam configured to move the first contact portion between the first pressing position and the first non-pressing position;
a second fixing member configured to be attached to or detached from the first fixing member, the second fixing member including a second core configured to be inserted into a second shaft hole of a second roll sheet, the second shaft hole having a second inner diameter larger than the first inner diameter; and
a second contact portion formed of an elastic body disposed in the second fixing member, the second contact portion being configured to move between a second pressing position where the second contact portion contacts an inner peripheral surface of the second shaft hole and presses the second shaft hole radially outward and a second non-pressing position located on a radially inward side of the second pressing position, wherein
in a state where the second fixing member is attached to the first fixing member, the cam moves the second contact portion between the second pressing position and the second non-pressing position.

Further features of the present invention will become apparent from the following description of exemplary embodiments with reference to the attached drawings.

### BRIEF DESCRIPTION OF THE DRAWINGS

FIG. 1 is a perspective view of a recording device of an embodiment;

FIG. 2 is a perspective view of a recording device at the time of performing roll set;

FIG. 3 is a schematic cross-sectional view of a conveying path of s sheet in the recording device;

FIGS. 4A to 4C are diagrams for describing a roll support member in the recording device;

FIG. 5 is an external view of a spindle flange of Embodiment 1;

FIG. 6 is an external view of a first contact portion of Embodiment 1;

FIGS. 7A and 7B are external views of a cam of Embodiment 1;

FIG. 8A is a schematic diagram of a first position when a 2-inch roll is attached according to Embodiment 1;

FIG. 8B is a schematic diagram of a first position when a 2-inch roll is attached according to Embodiment 1;

FIG. 9A is a schematic diagram of a second position when a 2-inch roll is attached according to Embodiment 1;

FIG. 9B is a schematic diagram of a second position when a 2-inch roll is attached according to Embodiment 1;

FIG. 10 is an external view of an attachment of Embodiment 1;

FIG. 11 is an external view when the attachment of Embodiment 1 is attached to the spindle flange;

FIG. 12 is an external view of a second contact portion of Embodiment 1;

FIG. 13A is a schematic diagram of a first position when a 3-inch roll is attached according to Embodiment 1;

FIG. 13B is a schematic diagram of a first position when a 3-inch roll is attached according to Embodiment 1;

FIG. 14A is a schematic diagram of a second position when a 3-inch roll is attached according to Embodiment 1;

FIG. 14B is a schematic diagram of a second position when a 3-inch roll is attached according to Embodiment 1;

FIG. 15 is an external view of a spindle flange of Embodiment 2;

FIG. 16 is an external view of a first contact portion of Embodiment 2;

FIG. 17 is an external view of a cam of Embodiment 2;

FIG. 18 is an external view of a grip portion of Embodiment 2;

FIG. 19 is a schematic diagram of a first position when a 2-inch roll is attached according to Embodiment 2;

FIG. 20 is a schematic diagram of a second position when a 2-inch roll is attached according to Embodiment 2;

FIG. 21 is an external view of an attachment of Embodiment 2;

FIG. 22 is an external view when the attachment of Embodiment 2 is attached to the spindle flange;

FIG. 23 is an external view of a second contact portion of Embodiment 2;

FIG. 24 is a schematic diagram of a first position when a 3-inch roll is attached according to Embodiment 2;

FIG. 25 is a schematic diagram of a second position when a 3-inch roll is attached according to Embodiment 2;

FIG. 26 is an external view of a non-reference side spindle flange of Embodiment 3;

FIG. 27 is an external view of a spindle lock flange of Embodiment 3;

FIG. 28 is an external view of a spindle lock lever of Embodiment 3;

FIG. 29 is an external view when the spindle lock is unlocked according to Embodiment 3;

FIG. 30 is an external view when the spindle lock is locked according to Embodiment 3;

FIG. 31 is an external view of a non-reference side spindle flange when an intermediate link mechanism is unlocked according to Embodiment 3; and

FIG. 32 is an external view of a non-reference side spindle flange when the intermediate link mechanism is locked according to Embodiment 3.

### DESCRIPTION OF THE EMBODIMENTS

Embodiments of the present invention will now be described with reference to the drawings. Dimensions, materials and shapes of components described in the following embodiments and relative positions thereof should be appropriately changed in accordance with the configuration of the device to which the present invention is in applied, and with various conditions, and are not intended to limit the scope of the present invention to the following embodiments.

### Basic Configuration of Device

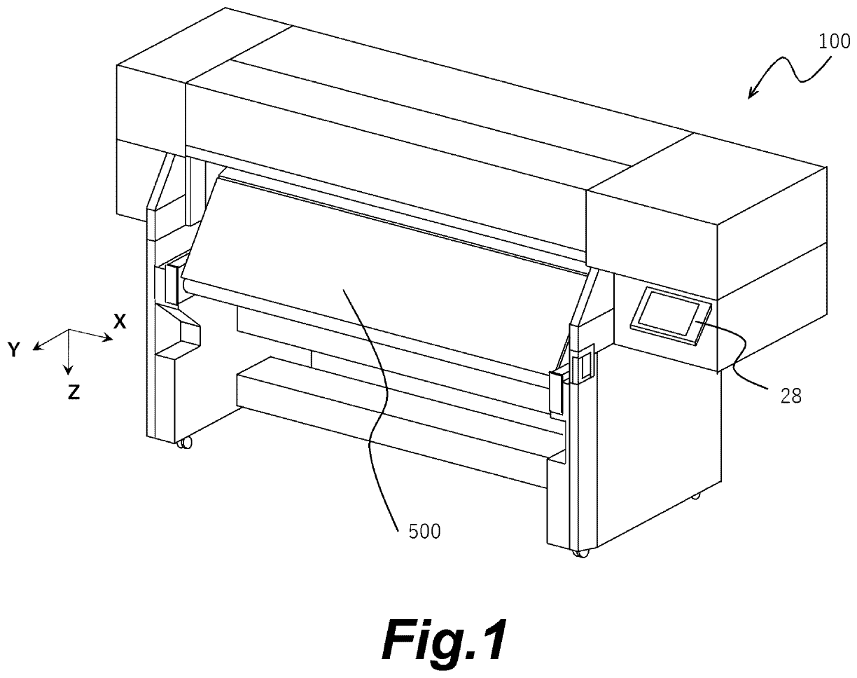

FIGS. 1 to 3 are diagrams for describing a basic configuration of an embodiment. A recording device 100 of the embodiment includes a roll set portion 200, which is a holding device to hold a roll sheet (rolled sheet), which is a sheet rolled around a hollow shaft having a shaft hole. The recording device 100 is an inkjet recording device which records an image on a sheet type recording medium (sheet) supplied from the roll set portion 200. In this embodiment, an example of applying the present invention to the inkjet recording device will be described, but the present invention is applicable to any recording device having the roll set portion 200, and the printing system thereof is not limited to an inkjet recording device. In the following description, it is assumed that the X direction is a direction parallel with the axial direction (shaft line direction) of the hollowed shaft of the roll sheet, the Y direction is a direction that is vertical to the axial direction and parallel with the horizontal direction, and the Z direction is a vertical direction.

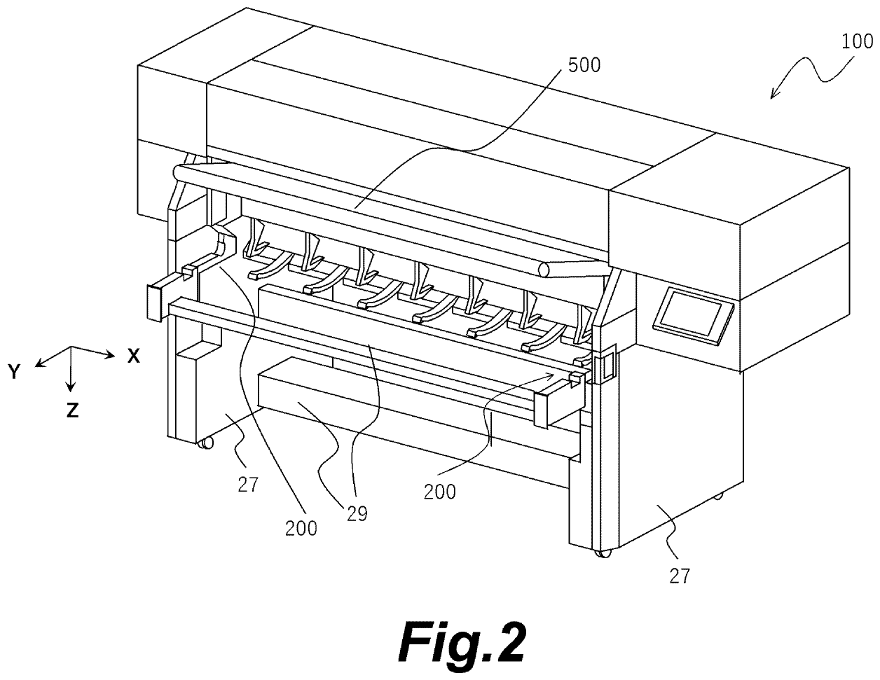

FIG. 1 is a perspective view of the recording device 100 which can record an image on a sheet supplied from a roll sheet generated by rolling up a sheet 1, and can wind up the recorded sheet 1. FIG. 2 is a perspective view of the recording device 100 at the time of performing roll set in the recording device 100. By setting a sheet delivery guide portion 500 to an open state, a roll sheet can be set in a sheet feeding portion. The recording device 100 includes the roll set portion 200, which is a holding device to hold the roll sheet.

When the sheet delivery guide portion 500 is in open state, a roll sheet can be set in the roll set portion 200. When the sheet delivery guide portion 500 is in closed state, the sheet drawn out of the roll sheet that is set in the roll set portion 200 reaches a print portion via a sheet conveying portion, and after an image is printed on the sheet by the print portion, the sheet is discharged to the sheet delivery guide portion 500. The user can input various commands and the like to the recording device 100, to specify the size of the roll sheet, the type of the roll, and the like, using various switches provided on the operation panel 28.

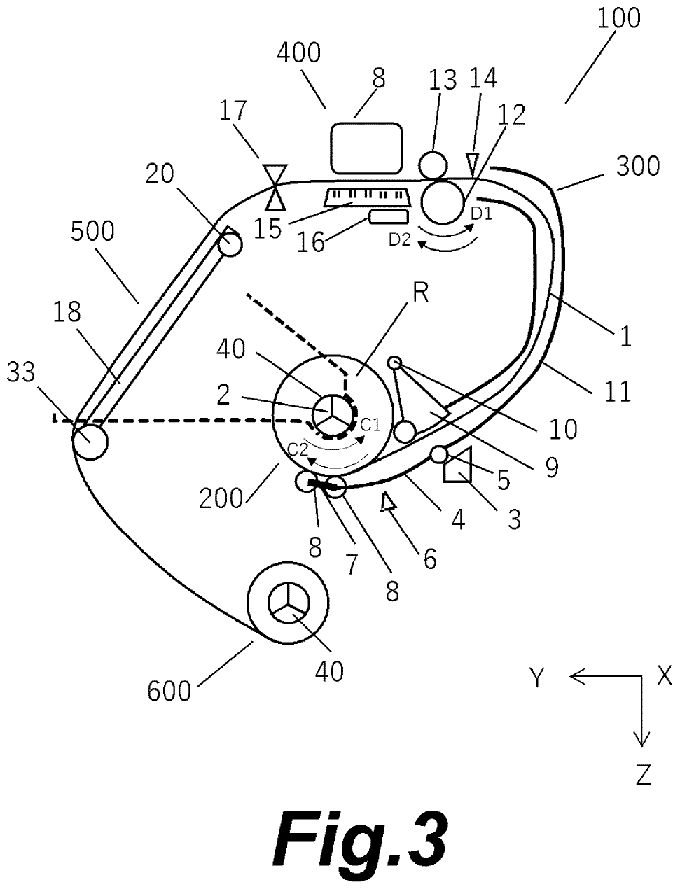

FIG. 3 is a schematic cross-sectional view of a key portion of the recording device 100. The sheet 1 drawn out from a roll sheet R, which is set in the roll set portion 200, is connected to a winding portion 600 and wound up. The sheet 1 drawn out from the roll sheet R, which is set in the roll set portion 200, is conveyed to a print portion 400 (a recording portion that can print the image) via a sheet conveying portion 300. The print portion 400 prints an image on the sheet 1 by ejecting ink from an inkjet type print head 8. The print head 8 ejects ink from an ejection port using an ejection energy generation element, such as an electro-thermal conversion element (heater) and a piezoelectric element. In the case of using an electro-thermal conversion element, ink is foamed by the heating thereof, and ink can be ejected from the ejection port using the foaming energy thereof. The print head 8 is not limited to the inkjet type, and the print type of the print portion 400 is also not limited, and may be a serial scan type or a full-line type, for example. In the case of the serial scan type, an image is printed using the conveying operation of the sheet 1, and scanning with the print head 8 in a direction intersecting with the conveying direction of the sheet 1. In the case of the full-line type, an image is printed while conveying the sheet 1 continuously using a long print head 8, which extends in a direction intersecting with the conveying direction of the sheet 1.

A shaft-shaped roll support member 2 is inserted into a hollow shaft 40 (also called a “sheet tube”) of the roll sheet R, and the roll support member 2 is driven by a roll driving motor to perform normal rotation or reverse rotation. Thereby the roll sheet R performs normal rotation or reverse rotation (arrow C1 or C2 direction) while the center portion thereof is held. The roll set portion 200 includes: a driving portion 3, an arm member (moving body) 4, an arm rotation shaft 5, a first sheet sensor 6, an oscillation member 7, a driven rotator (pressure contact body) 8, a separation flapper (upper guide body) 9, and a flapper rotation shaft 10.

A sheet feeding side conveying guide 11 supports the front and rear surfaces of the sheet 1 drawn from the roll set portion 200, and guides this sheet 1 to the print portion 400 in this state. A conveying roller 12 performs normal rotation or reverse rotation in the arrow D1 or D2 direction by the conveying roller driving motor. A nip roller 13 can be rotate-driven by the rotation of the conveying roller 12, and can be separated from the conveying roller 12 and the nip force can be adjusted by a nip roller specification motor (not illustrated). The conveying roller 12 is rotated when a second sheet sensor 14 detects the front end of the sheet 1. The speed of conveying the sheet 1 by the conveying roller 12 is set to be faster than the speed of drawing the sheet 1 by rotation of the roll sheet R, whereby back tension is applied to the sheet 1 so that the sheet 1 is conveyed in a stretched state. As a result, sagging of the sheet 1 is prevented, and the generation of creases of the sheet 1 and the generation of conveying errors can be suppressed.

A platen 15 of the print portion 400 adsorbs the rear face of the sheet 1 via suction holes formed on the platen 15 using negative pressure generated by a suction fan 16. Thereby the position of the sheet 1 can be controlled along the surface of the platen 15, and the print head 8 can print the image at high precision. A cutter 17 cuts the sheet 1 on which the image is printed.

A sheet delivery side conveying guide 18 installed in the sheet delivery guide portion 500 supports the rear face of the sheet 1 drawn from the print portion 400, and guides the sheet 1 to the winding portion 600 in this state. Here the front end of the sheet 1 is fixed at the hollow shaft 40 which is set in the winding portion 600, and the hollow shaft 40 that is set is rotated in accordance with the conveying speed of the conveying roller 12, whereby the sheet 1 which was printed by the print portion 400 can be wound up continuously. A driven roller 33 is installed at the edge of the winding side of the sheet delivery side conveying guide 18. Thereby damage to the medium that may be caused by bending at the driven roller 33 can be prevented, and conveying resistance at a bent portion can be decreased, which prevents the generation of major deflection between the conveying roller 12 and the driven roller 33. Because of this configuration, where the sheet 1 is conveyed along the sheet delivery side conveying guide 18, the sheet delivery side conveying guide 18 can be heated using a heater (not illustrated) when necessary, so as to assist thermally fixing the ink, ejected by the print portion 400, to the sheet 1. The sheet delivery side conveying guide 18 and the driven roller 33 can rotate around the sheet delivery guide rotation shaft 20. Thereby when the roll sheet R is attached to/detached from the roll set portion 200, the sheet delivery side conveying guide 18 and the driven roller 33 can be retracted upward by rotation, and the roll sheet R can be set without interfering with the sheet delivery guide portion 500.

The main unit leg portions 27 support the weight of the sheet conveying portion 300 and the print portion 400 on the upper part of the main unit from below, and also support the weight of the roll sheet R via the roll set portion 200. The main unit leg portions 27 contact the floor surface via casters, so as to release the weight of the recording device 100 to the floor surface. Linking portions 29 connect the main unit leg portions 27 on both sides in the sheet width direction, and prevent the falling of the main unit leg portions 27 and the like due to weight.

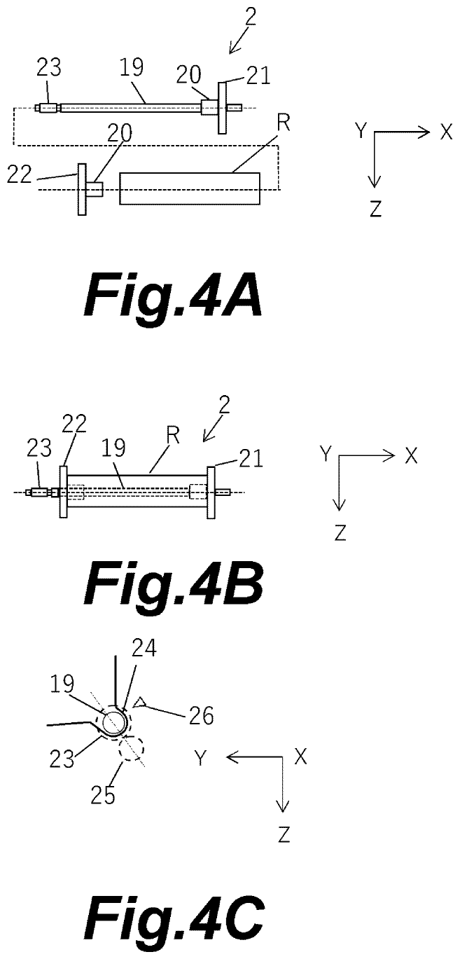

FIGS. 4A, 4B and 4C are diagrams for describing a procedure to set the roll sheet R in the roll set portion 200 using the roll support member 2. The roll support member 2 includes a spindle 19, a first friction member 31, a reference side spindle flange 21, a non-reference side spindle flange 22, and a spindle gear 23. The reference side spindle flange 21 is disposed on one end of the spindle 19, and the spindle gear 23 which rotates the spindle 19, is disposed on the other end. The first friction member 31 is disposed on the inner side of the reference side spindle flange 21 and the non-reference side spindle flange 22.

When the roll support member 2 is set on the roll sheet R, the non-reference side spindle flange 22 inserted into the spindle 19 is removed, then the spindle 19 is inserted into the hollow shaft 40 of the roll sheet R. The outer diameter of the spindle 19 is smaller than the inner diameter of the hollow shaft 40 of the roll sheet R, and a gap is created therebetween, hence the user can insert the spindle 19 into the hollow shaft 40 with very little force. When the edge of the roll sheet R on the right side in FIG. 4A touches the reference side spindle flange 21, the first friction member 31 on the inner side of the reference side spindle flange 21 is inserted into the hollow shaft 40 of the roll sheet R. Thereby the reference side spindle flange 21 is fixed to the roll sheet R. Then, with the spindle 19 being passed through the non-reference side spindle flange 22, the first friction member 31 on the inner side of the non-reference side spindle flange 22 is inserted into the hollow shaft 40 of the roll sheet R. Thereby the non-reference side spindle flange 22 is fixed to the roll sheet R.

In this way, the roll sheet R is attached to the roll support member 2, as illustrated in FIG. 4B. Then, as illustrated in FIG. 4C, both ends of the roll support member 2 are inserted into the spindle holders 24 of the roll set portion 200, whereby the setting of the roll sheet R is completed.

It is assumed here that the outer diameters of the reference side spindle flange 21 and the non-reference side spindle flange 22 are about 170 mm, for example. The maximum outer diameter of the roll sheet R is about 180 mm, for example, and the inner diameter of the hollow shaft 40 is 2 inches (50.8 mm) or 3 inches (76.2 mm). The outer diameters of the reference side spindle flange 21 and the non-reference side spindle flange 22, the maximum outer diameter of the roll sheet R, and the inner diameter of the hollow shaft 40 are not limited to the above-mentioned values.

The spindle holders 24 are disposed at positions corresponding to both ends of the spindle 19 respectively. The inner surface of the spindle holder 24 is formed in a U shape, and each end of the spindle 19 can be inserted from the opening side of the U shape. In a state where the roll support member 2 is inserted into the spindle holders 24, the spindle gear 23 is connected to a roll driving motor via the driving gear 25 on the roll set portion 200 side. When the roll sheet R along with the roll support member 2 are driven by the roll driving motor in normal rotation or reverse rotation, the sheet 1 can be supplied. The spindle holders 24 play a role of feeding support portions which support the roll support member 2 so as to feed the roll sheet R, whereby the position of the roll sheet R, with respect to the recording device 100, can be accurately determined. A roll sensor 26 detects the presence of the roll sheet R.

By using the spindle 19 to hold the roll sheet R like this, the roll sheet R is set in the roll set portion 200 by the spindle 19 and the spindle holders 24, regardless the width of the sheet. Therefore, the roll sheet R having a width corresponding to various sizes less than the length of the spindle 19, from such a large size as A0 and A1 to a small size, can be set. Further, the edge of the roll sheet R is inserted into the reference side spindle flange 21 fixed to the spindle 19, hence the reference side edge position of the roll sheet R can be determined without deviation in the roll set portion 200.

### Embodiment 1

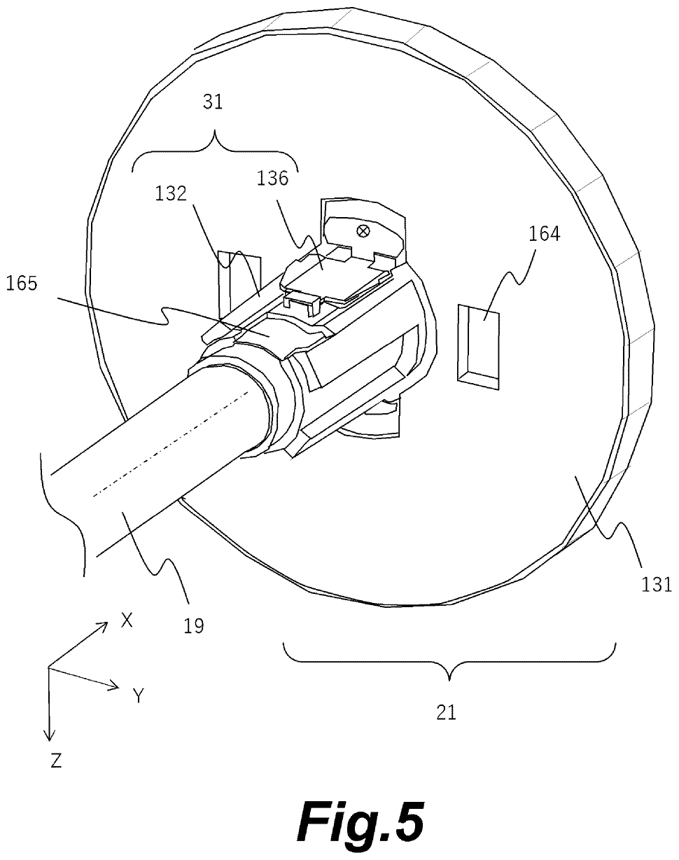

The procedure to attach the roll sheet R to the roll support member 2 was described with reference to FIGS. 4A to 4C, now the configuration of Embodiment 1, which allows to attach roll sheets R having different inner diameters of shift hole of the shafts to the roll set portion 200 (holding device), will be described with reference to FIGS. 5 to 14A and 14B.

First, attachment of a first roll sheet R1 having a first shaft hole 41 of which inner diameter is 2 inches (first inner diameter) will be described.

FIG. 5 is an external view of a spindle flange. The reference side spindle flange 21 includes a flat reference side flange surface 131 and attachment installation holes 164. The first friction member 31 is constituted of a reference side flange core 132 which protrudes from the reference side flange surface 131, and 2 (a pair of) first contact portions 136 which are disposed symmetrically with respect to the shaft line of the spindle 19.

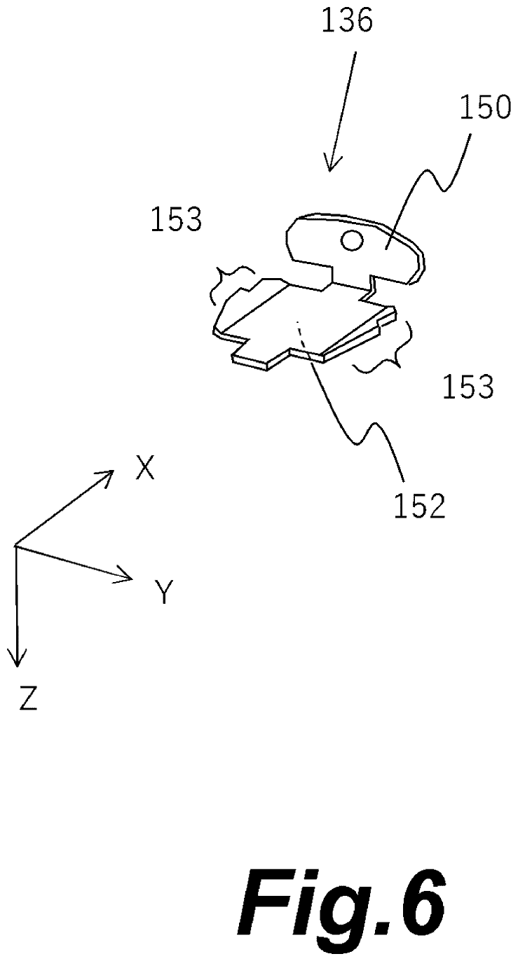

FIG. 6 is an external view of the first contact portion 136. The first contact portion 136 includes a fixing portion 150, which is fixed to the reference side spindle flange 21. The first contact portion 136 also includes a flat portion 152 to which a later mentioned first pressing portion 161 is pressed. The first contact portion 136 also includes a pair of interference portions 153, which contact with the inner periphery of the first shaft hole 41 of the first roll sheet R1. Further, a rotating cam 160 is disposed inside the reference side spindle flange 21.

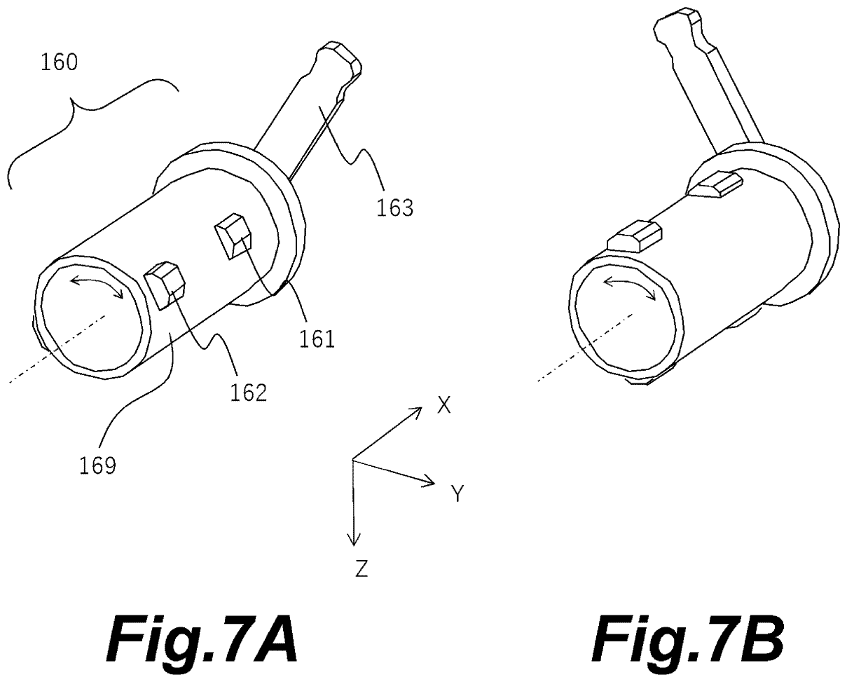

FIGS. 7A and 7B are external views of the rotating cam 160. The rotating cam 160 includes a lever portion 163, the two first pressing portions 161 which are disposed symmetrically with respect to the shaft line of the spindle 19, and 2 second pressing portions 162 which are also disposed symmetrically with respect to the shaft line of the spindle 19. The rotating cam 160 has a cylindrical portion 169 which is coaxial with the spindle 19, and the first pressing portions 161 and the second pressing portions 162 are disposed on the outer peripheral surface of the cylindrical portion 169. The rotating cam 160 is rotatably supported inside the reference side spindle flange 21, and can be switched between the attitude at the first position illustrated in FIG. 7A and the attitude at the second position illustrated in FIG. 7B.

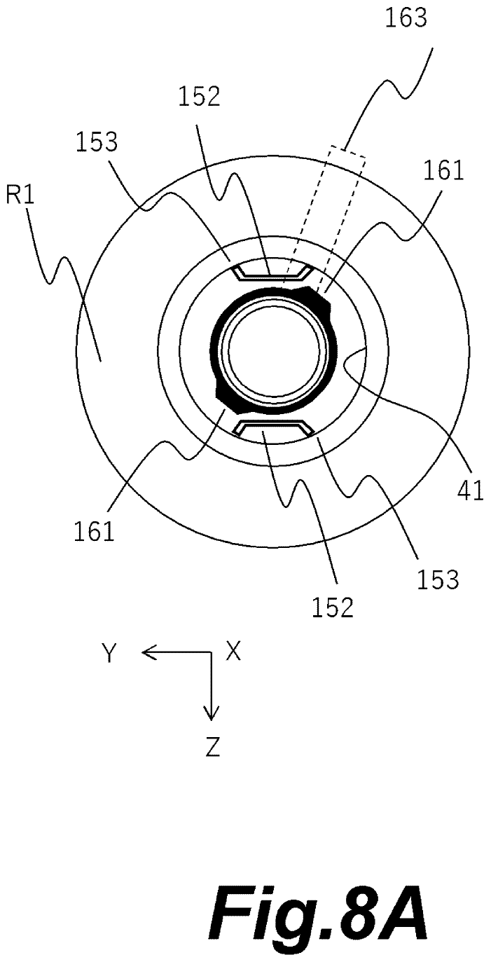

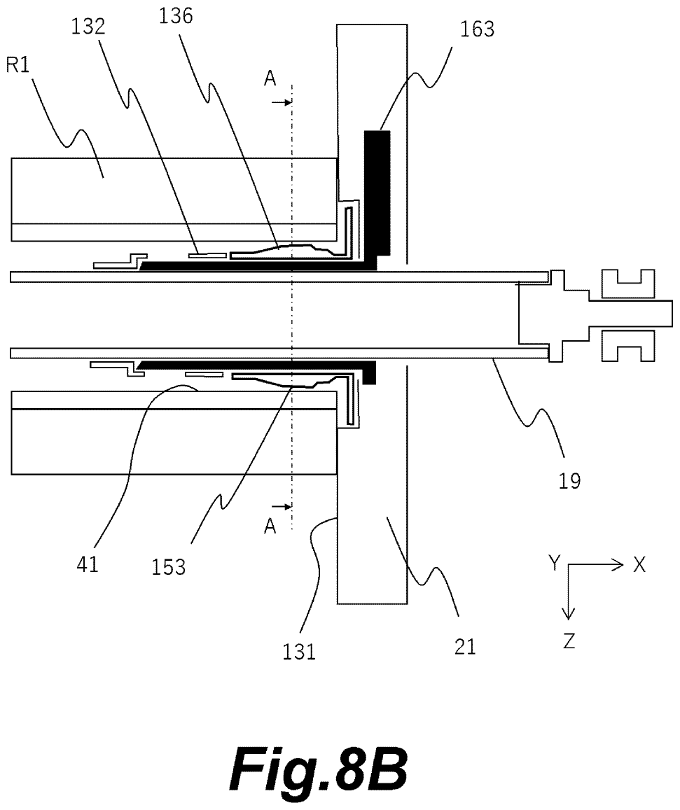

FIG. 8B is a cross-sectional view of the reference side spindle flange 21 sectioned at a plane including the shaft line of the first roll sheet R1 (shaft line of the spindle 19), and FIG. 8A is a cross-sectional view at the A-A line in FIG. 8B. FIGS. 8A and 8B indicate the attitude of the first contact portion 136 and the rotating cam 160 at the first position. In the attitude at the first position, the first pressing portion 161 and the flat portion 152 of the first contact portion 136 do not contact.

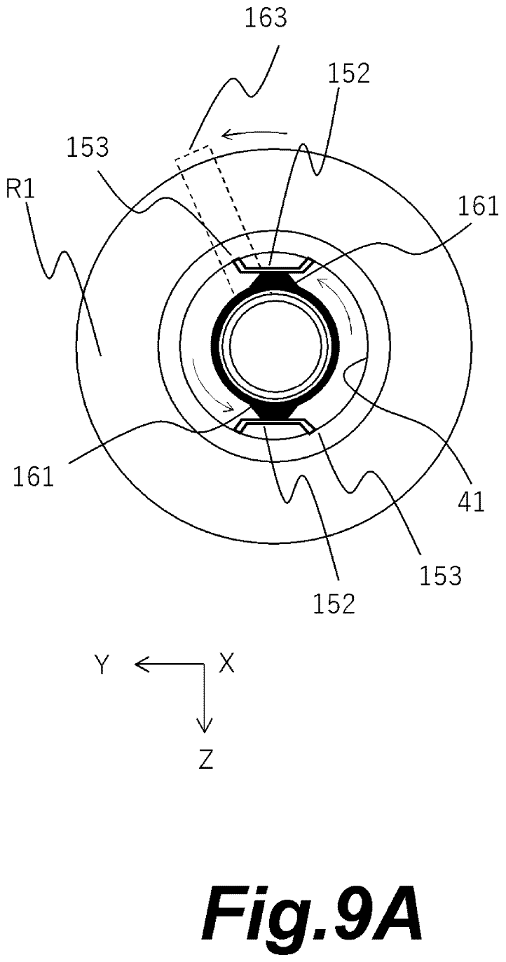

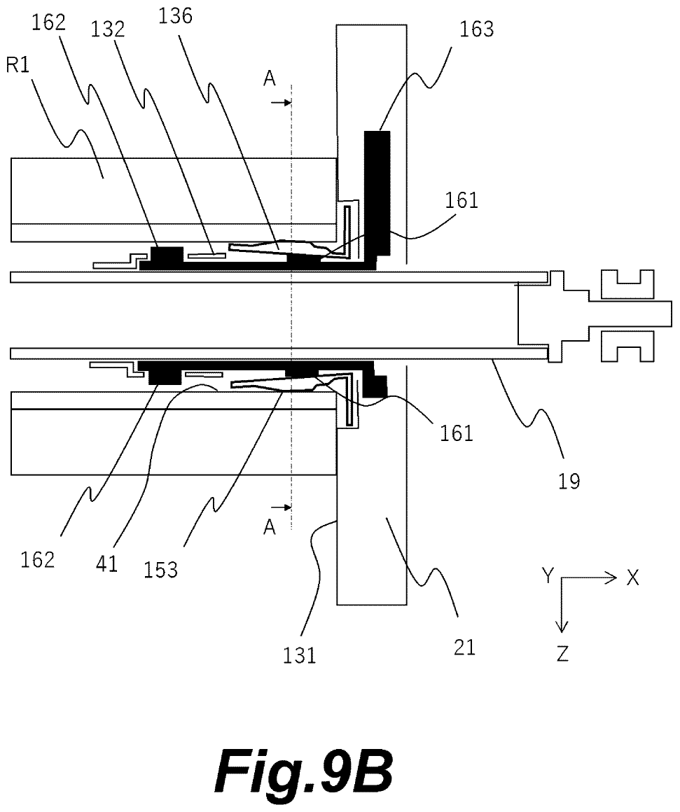

FIGS. 9A and 9B indicate the attitude of the first contact portion 136 and the rotating cam 160 at the second position. FIG. 9B is a cross-sectional view of the reference side spindle flange 21 sectioned at the plane including the shaft line of the first roll sheet R1 (shaft line of the spindle 19), and FIG. 9A is a cross-sectional view at the A-A line in FIG. 9B. In the attitude at the second position, the first pressing portion 161 is pressing the flat portion 152 of the first contact portion 136. The first position and the second position can be switched by operating the lever portion 163 in the rotating direction around the shaft line of the spindle 19.

To attach the reference side spindle flange 21 to the first roll sheet R1, the rotating cam 160 is switched to the first position, as illustrated in FIGS. 8A and 8B. The reference side flange core 132 is configured so as to not interfere with the first shaft hole 41 of the first roll sheet R1. The interference portion 153 of the first contact portion 136 is also configured so as to not interfere at all or to interfere very little with the first shaft hole 41 of the first roll sheet R1. The second pressing portion 162 is also formed so as to not interfere with the first shaft hole 41 of the first roll sheet R1. Therefore, when the reference side spindle flange 21 is attached to the first roll sheet R1, friction between the interference portion 153 and the inner periphery of the first shaft hole 41 of the first roll sheet R1 can be decreased, and operability is improved.

After the reference side spindle flange 21 is inserted into the first roll sheet R1, the rotating cam 160 is switched to the second position, as illustrated in FIGS. 9A and 9B. At the second position, the first pressing portion 161 presses the flat portion 152 of the first contact portion 136. Then the interference portion 153 contacts the first shaft hole 41 of the first roll sheet R1, and the reference side spindle flange 21 is fixed to the first shaft hole 41 of the first roll sheet R1. The inner diameter of the first shaft hole 41 of the first roll sheet R1 varies (large or small inner diameters), depending on the type of sheet, the manufacturing lot, and the like. However, the first contact portion 136 is an elastic body and can be elastically deformed, whereby variations of the inner diameter of the first shaft hole 41 of the first roll sheet R1 can be absorbed, and the reference side spindle flange 21 can be fixed to the first roll sheet R1.

The non-reference side spindle flange 22 also has a configuration similar to the reference side spindle flange 21, and the non-reference side spindle flange 22 is also fixed to the first roll sheet R1. By the above-mentioned procedure, the first roll sheet R1, having the first shaft hole 41 of which inner diameter is 2 inches, can be attached to the roll support member 2.

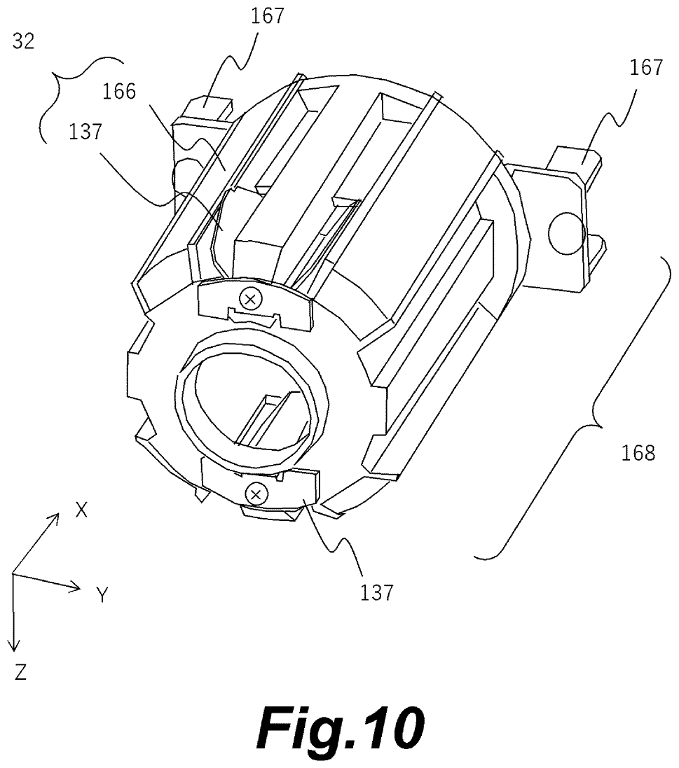

Next, attachment of a second roll sheet R2, having a second shaft hole 42 of which inner diameter is 3 inches (second diameter), will be described. As illustrated in FIG. 10, an attachment member 168 includes a second friction member 32 and an attachment installation portion 167. The second friction member 32 is constituted of an attachment core 166 and 2 (a pair of) second contact portions 137, which are disposed symmetrically with respect to the shaft line of the spindle 19.

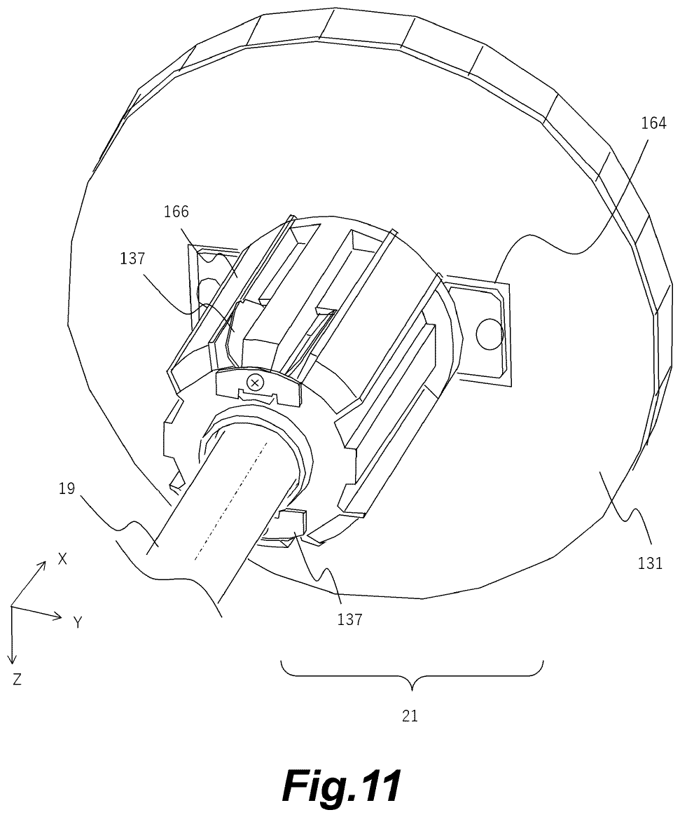

FIG. 11 is an external view of a state where the attachment member 168 is attached to the reference side spindle flange 21. The attachment installation portion 167 is inserted into an attachment installation hole portion 164, and the attachment member 168 is fixed to the reference side spindle flange 21 by a snap-fit type, screw fastening type, or the like.

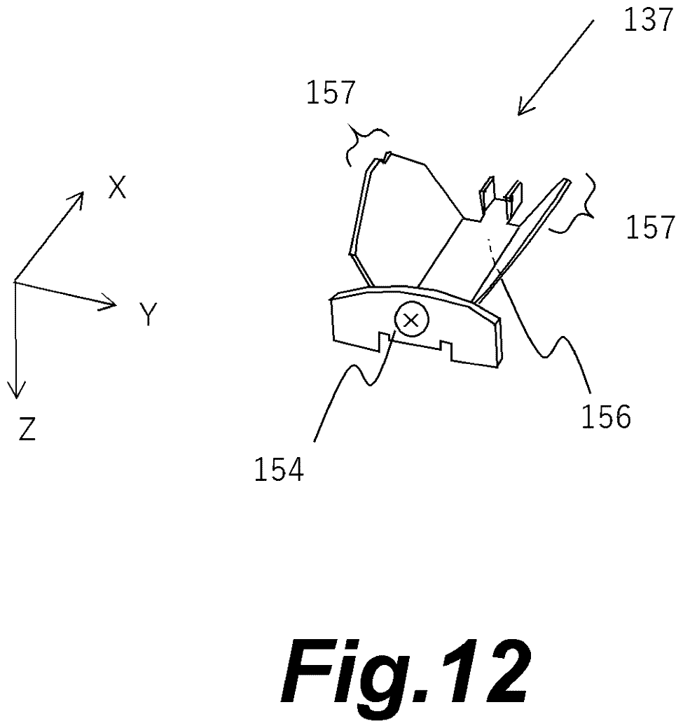

FIG. 12 is an external view of the second contact portion 137. The second contact portion 137 includes a fixing portion 154 which is fixed to the attachment member 168. The second contact portion 137 also includes a flat portion 156, to which the above mentioned second pressing portion 162 is pressed. The second contact portion 137 also includes an interference portion 157 which contacts with the inner periphery of the hollow shaft 40 of the second roll sheet R2. Further, the rotating cam 160 is disposed inside the reference side spindle flange 21, as mentioned above. Just like the case of attachment of the 2-inch standard first roll sheet R1, the attitude at the first position illustrated in FIG. 7A and the attitude at the second position illustrated in FIG. 7B can be switched.

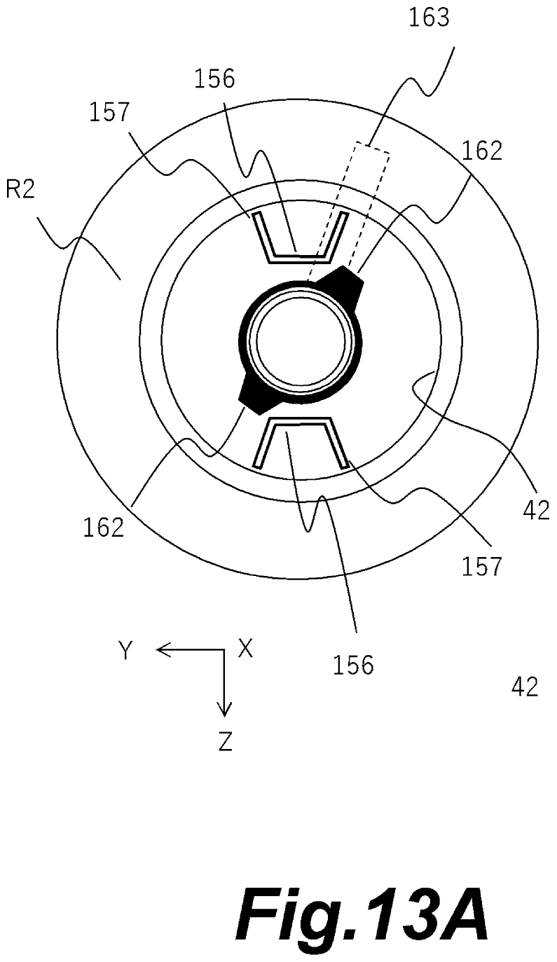

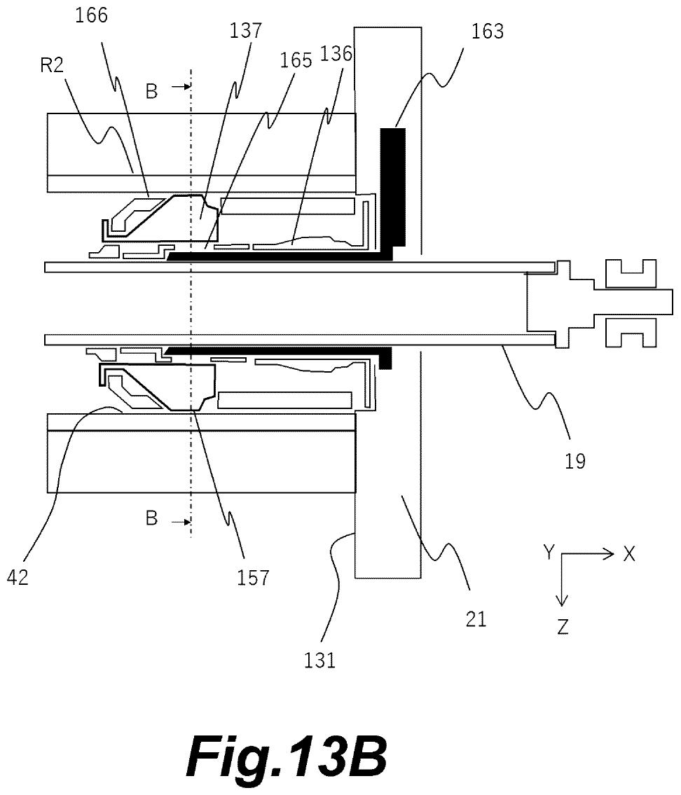

FIG. 13B is a cross-sectional view of the reference side spindle flange 21 sectioned at a plane including the shaft line of the second roll sheet R2 (shaft line of the spindle 19), and FIG. 13A is a cross-sectional view at the B-B line in FIG. 13B. FIGS. 13A and 13B indicate the attitude of the second contact portion 137 and the rotating cam 160 at the first position. In the attitude at the first position, the second pressing portion 162 and the flat portion 156 of the second contact portion 137 do not contact.

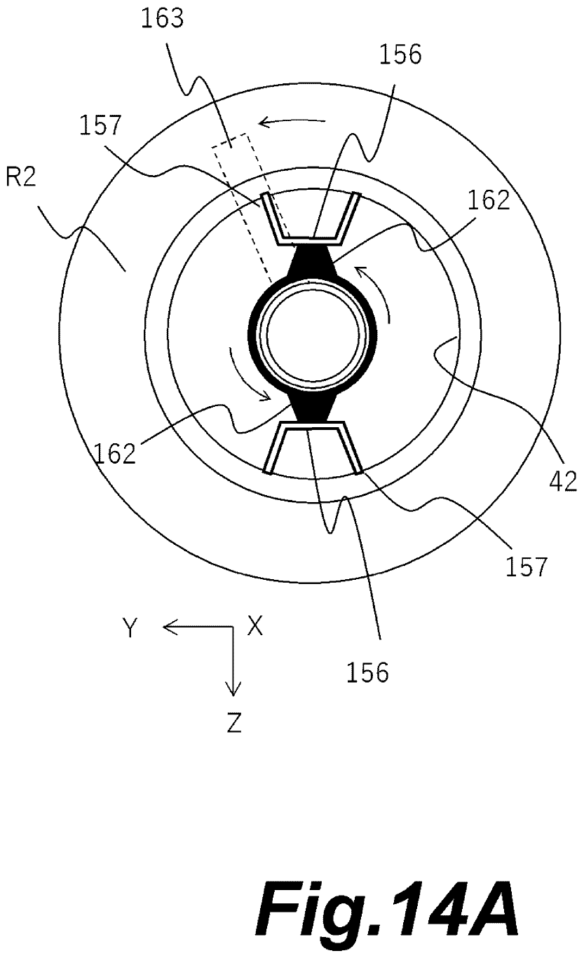

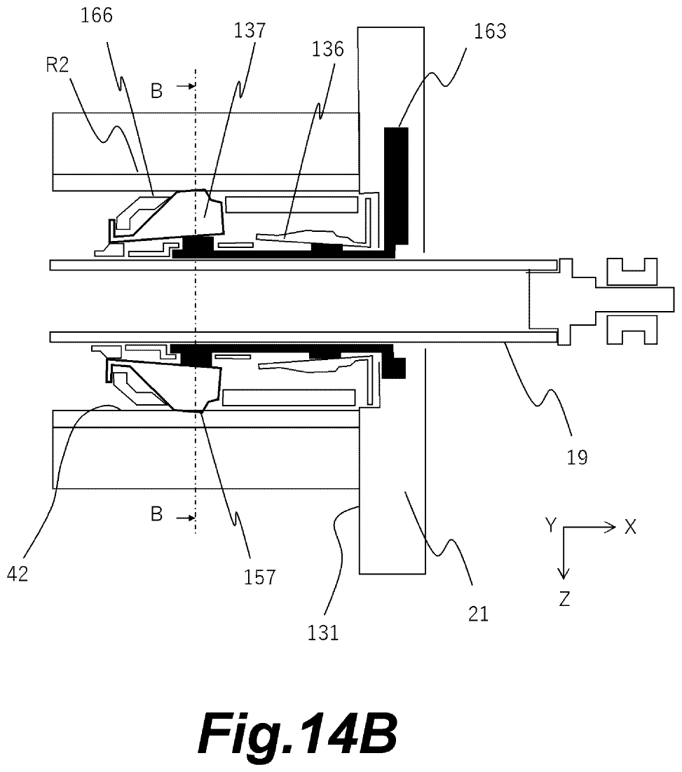

FIGS. 14A and 14B indicate the attitude of the second contact portion 137 and the rotating cam 160 at the second position. FIG. 14B is a cross-sectional view of the reference side spindle flange 21 sectioned at the plane including the shaft line of the second roll sheet R2 (shaft line of the spindle 19), and FIG. 14B is a cross-sectional view at the B-B line in FIG. 14B. In the attitude at the second position, the second pressing portion 162 presses the flat portion 156 of the second contact portion 137 through an opening portion 165 disposed on the reference side flange core 132. The first position and the second position can be switched by operating the lever portion 163 in the rotating direction around the shaft line of the spindle 19.

To attach the reference side spindle flange 21 to the second roll sheet R2, the rotating cam 160 is switched to the first position, as illustrated in FIGS. 13A and 13B. The attachment core 166 is configured so as to not interfere with the second shaft hole 42 of the second roll sheet R2. The interference portion 157 of the second contact portion 137 is also configured so as to not interfere at all or to interfere very little with the second shaft hole 42 of the second roll sheet R2. Therefore, when the reference side spindle flange 21 is attached to the second roll sheet R2, friction between the interference portion 157 and the inner periphery of the second shaft hole 42 of the second roll sheet R2, can be decreased, and operability is improved.

After the reference side spindle flange 21 is inserted into the second roll sheet R2, the rotating cam 160 is switched to the second position, as illustrated in FIGS. 14A and 14B. At the second position, the second pressing portion 162 presses the flat portion 156 of the second contact portion 137. Then the interference portion 157 contacts the second shaft hole 42 of the second roll sheet R2, and the reference side spindle flange 21 is fixed to the second shaft hole 42 of the second roll sheet R2.

The inner diameter of the second shaft hole 42 of the second roll sheet R2 varies (large or small inner diameters), depending on the type of sheet, the manufacturing lot, and the like. However, the second contact portion 137 is an elastic body and can be elastically deformed, whereby variations of the inner diameter of the second shaft hole 42 of the second roll sheet R2 can be absorbed, and the reference side spindle flange 21 can be fixed to the second roll sheet R2.

The non-reference side spindle flange 22 also has a configuration similar to the reference side spindle flange 21, and the non-reference side spindle flange 22 is also fixed to the second roll sheet R2. By the above-mentioned procedure, the second roll sheet R2, having the second shaft hole 42 of which inner diameter is 3 inches, can be attached to the roll support member 2.

As described above, in Embodiment 1, the first roll sheet R1, having the first shaft hole 41 of which inner diameter is the first inner diameter (e.g. 2 inches), and the second roll sheet R2, having the second shaft hole 42 of which inner diameter is the second inner diameter (e.g. 3 inches) which is larger than the first inner diameter, can be attached. The roll set portion 200 (holding device) includes the spindle 19, which is a shaft member inserted into the shaft hole of the roll sheet, and the spindle holders 24 which are bearings to support both ends of the spindle 19.

The reference side spindle flange 21 is the first fixing member having the reference side flange core 132, which is the first core that can be inserted into the first shaft hole 41 of the first roll sheet R1. The first contact portion 136, made of elastic, is disposed on the reference side spindle flange 21, and can move to the first pressing position indicated in FIGS. 9A and 9B and the first non-pressing position indicated in FIGS. 8A and 8B. In the first pressing position, the first contact portion 136 contacts the inner peripheral surface of the first shaft hole 41 of the first roll sheet R1, and radially presses the inner peripheral surface. The first non-pressing position is a position located on the radially inward side of the first pressing position. The rotating cam 160 is a cam which moves the first contact portion 136 between the first pressing position and the first non-pressing position in a state where the attachment member 168 is not attached to the reference side spindle flange 21.

The attachment member 168 is the second fixing member which can be attached to/detached from the reference side spindle flange 21. The attachment member 168 includes the attachment core 166, which is the second core that can be inserted into the second shaft hole 42 of the second roll sheet R2. The second contact portion 137, made of elastic, is disposed on the attachment member 168, and can move to the second pressing position indicated in FIGS. 14A and 14B and the second non-pressing position indicated in FIGS. 13A and 13B. At the second pressing position, the second contact portion 137 contacts the inner peripheral surface of the second shaft hole 42 of the second roll sheet R2, and presses the inner peripheral surface radially outward. The second non-pressing position is a position located on the radially inward side of the second pressing position. The rotating cam 160 moves the second contact portion 137 between the second pressing position and the second non-pressing position in a state where the attachment member 168 is attached to the reference side spindle flange 21.

The rotating cam 160 can move between the first position indicated in FIGS. 7A, 8A, 8B, 13A and 13B and the second position indicated in FIGS. 7B, 9A, 9B, 14A and 14B. The rotating cam 160 includes the first pressing portion 161 and the second pressing portion 162. In the state where the attachment member 168 is not attached to the reference side spindle flange 21, the first pressing portion 161 does not contact the first contact portion 136 at the first position. The first pressing portion 161 contacts the first contact portion 136 at the second position, and presses the first contact portion 136 radially outward. In the state where the attachment member 168 is attached to the reference side spindle flange 21, the second pressing portion 162 does not contact the second contact portion 137 at the first position. The second pressing portion 162 contacts the second contact portion 137 at the second position, and presses the second contact portion 137 radially outward.

The rotating cam 160 includes the cylindrical portion 169, which is coaxial with the spindle 19 and to which the spindle 19 is inserted, and can move between the first position and the second position by the cylindrical portion 169 rotating around the spindle 19. The first contact portion 136 and the second contact portion 137 are disposed at different positions in the axial direction of the spindle 19, and at some positions (phases) in the circumferential direction of the spindle 19. In Embodiment 1, the second contact portion 137 is disposed at a position that is closer to the center of the spindle 19 than the first contact portion 136 in the axial direction. In other words, the second contact portion 137 is disposed closer to the inlet of the shaft hole of the roll sheet (inlet on the side where the reference side spindle flange 21 is fixed) than the first contact portion 136 in the axial direction. The first pressing portion 161 and the second pressing portion 162 are disposed at positions corresponding to the first contact portion 136 and the second contact portion 137 respectively on the cylindrical portion 169 in the axial direction. The first contact portion 136 and the second contact portion 137 are metal leaf springs respectively. The lever portion 163 is an operation member with which the user can perform operation to move the rotating cam 160.

In the case of setting the first roll sheet R1 in the roll set portion 200, the reference side flange core 132 is inserted into the first shaft hole 41 in a state where the attachment member 168 is not attached to the reference side spindle flange 21 and the first contact portion 136 is at the first non-pressing position. Then the first contact portion 136 is moved to the first pressing position by the rotating cam 160, and the reference side spindle flange 21 is fixed to the first shaft hole 41, whereby the first roll sheet R1 is fixed to the spindle 19. In the state where the first roll sheet R1 is set in the roll set portion 200, the print head 8 of the recording device 100 performs recording on the sheet 1 (first sheet) supplied from the first roll sheet R1.

In the case of setting the second roll sheet R2 in the roll set portion 200, the attachment core 166 is inserted into the second shaft hole 42 in a state where the attachment member 168 is attached to the reference side spindle flange 21, and the second contact portion 137 is at the second non-pressing position. Then the second contact portion 137 is moved to the second pressing position by the rotating cam 160, and the attachment member 168 is fixed to the second shaft hole 42, whereby the second roll sheet R2 is fixed to the spindle 19. In the state where the second roll sheet R2 is set in the roll set portion 200, the print head 8 of the recording device 100 performs recording on the sheet 1 (second sheet) supplied from the second roll sheet R2.

The first contact portion 136 moves to the first non-pressing position by moving the rotating cam 160 to the first position in the state where the attachment member 168 is not attached to the reference side spindle flange 21. The first contact portion 136 moves to the first pressing position by moving the rotating cam 160 to the second position.

The second contact portion 137 moves to the second non-pressing position by moving the rotating cam 160 to the first position in the state where the attachment member 168 is attached to the reference side spindle flange 21. The second contact portion 137 moves to the second pressing position by moving the rotating cam 160 to the second position.

As described above, in the holding device which can use a plurality of rolled recording media having different inner diameters (e.g. 2 inches, 3 inches), Embodiment 1 allows to decrease the force required to insert or extract the sheet to attached to or detach from the holding device. Thereby operability in the operation to attach or detach the sheet to/from the holding device can be improved.

### Embodiment 2

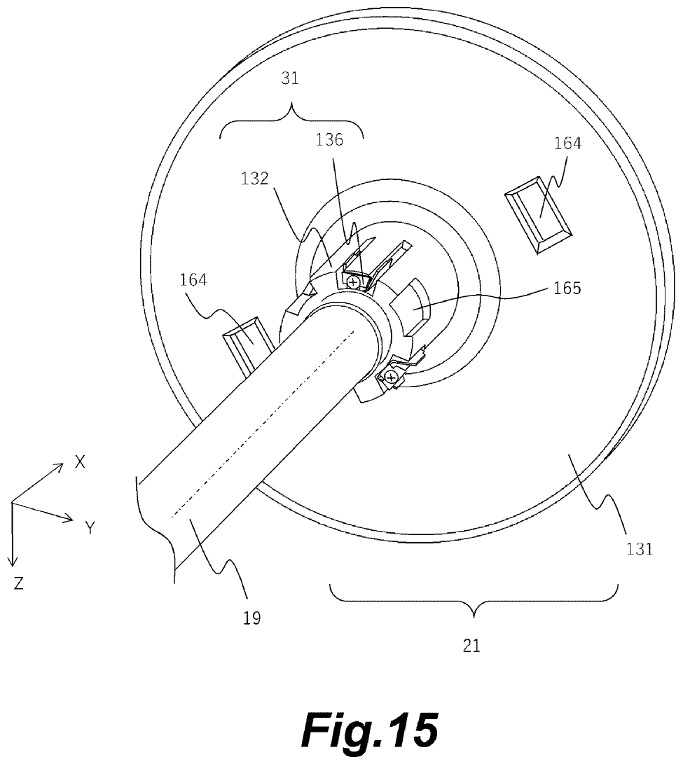

Now the configuration of Embodiment 2, which allows to attach roll sheets having different inner diameters of shaft hole of the shafts to the roll set portion 200 (holing device), will be described with reference to FIGS. 15 to 25.

First, attachment of a first roll sheet R1 having a first shaft hole 41 of which inner diameter is 2 inches (first inner diameter) will be described.

FIG. 15 is an external view of a spindle flange. The reference side spindle flange 21 includes the flat reference side flange surface 131 and the attachment installation hole portions 164. The first friction member 31 is constituted of the reference side flange core 132 which protrudes from the reference side flange surface 131, and a plurality of first contact portions 136 which are disposed symmetrically with respect to the shaft line of the spindle 19.

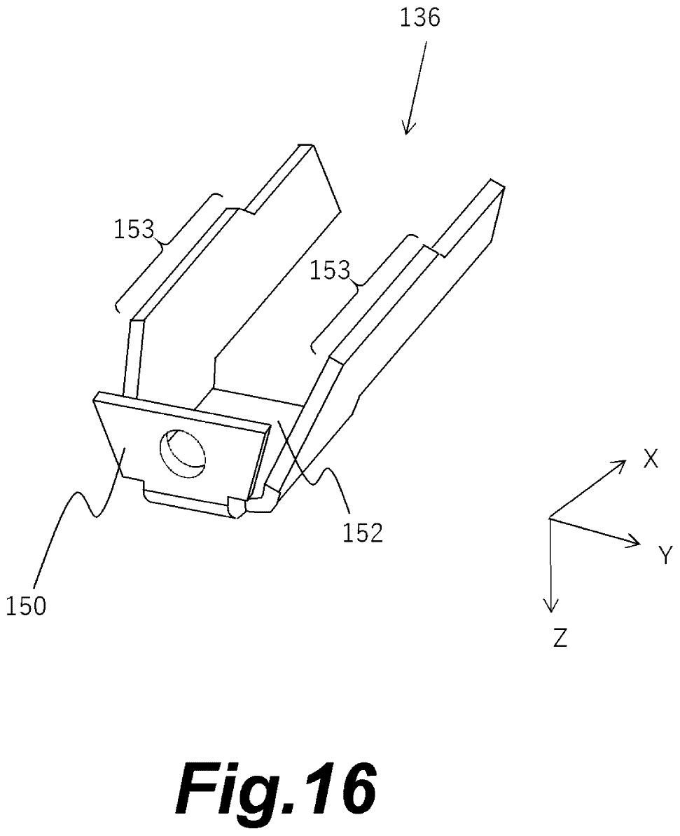

FIG. 16 is an external view of the first contact portion 136. The first contact portion 136 includes the fixing portion 150 which is fixed to the reference side spindle flange 21. The first contact portion 136 also includes the flat portion 152 to which a later mentioned pressing portion 171 is pressed. The first contact portion 136 also includes an interference portion 153, which contacts with the inner periphery of the first shaft hole 41 of the first roll sheet R1.

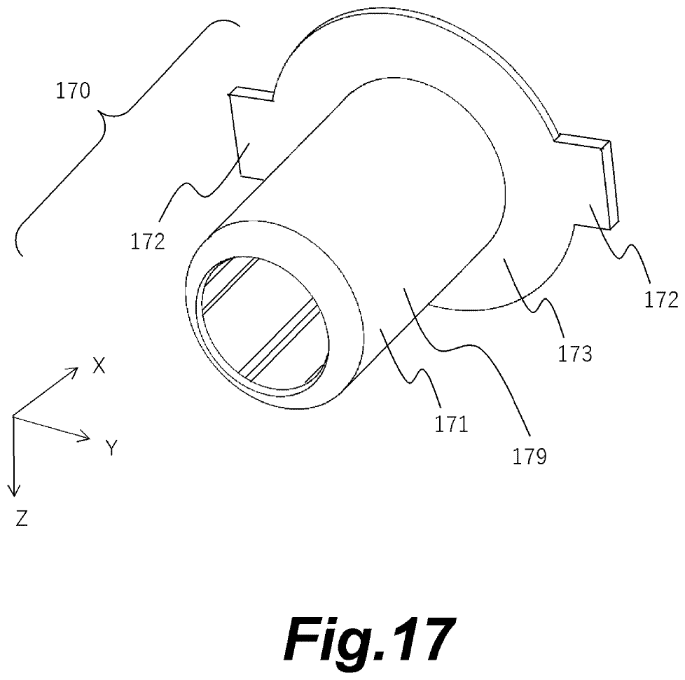

A linearly moving cam 170 is disposed inside the reference side spindle flange 21. FIG. 17 is an external view of the linearly moving cam 170. The linearly moving cam 170 includes: a cylindrical portion 179 which is coaxial with the spindle 19; a flat portion 172 to which a later mentioned contact portion 176 and contact portion 177 contact; and a ring-shaped flat portion 173 to which a later mentioned compression spring 178 contacts. The end portion of the cylindrical portion 179 functions as a pressing portion 171. The linearly moving cam 170 is supported inside the reference side spindle flange 21, so as to be linearly movable.

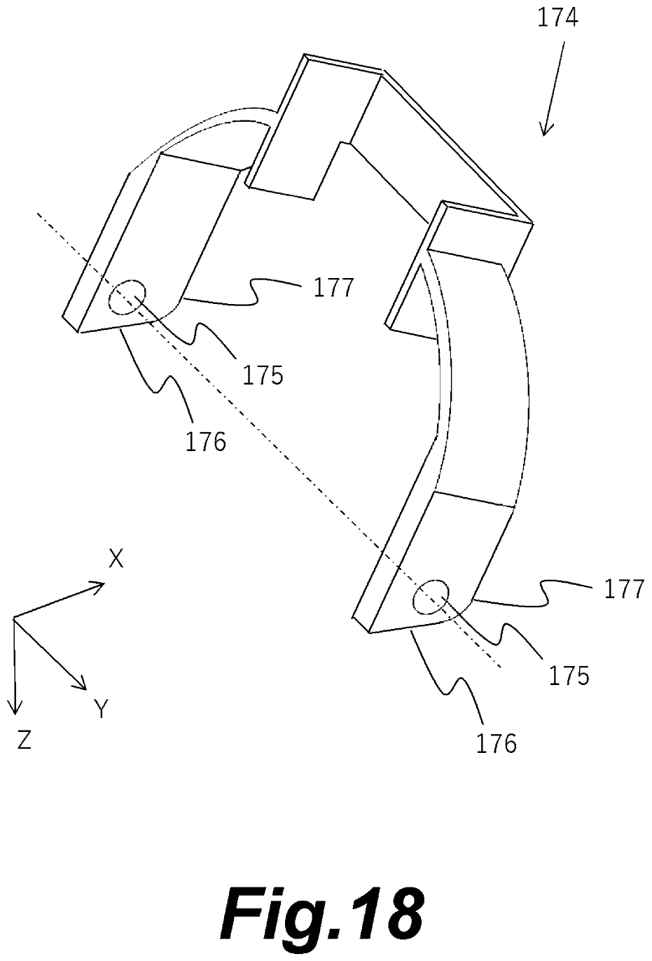

FIG. 18 is an external view of a grip portion 174. The grip portion 174 includes a bearing portion 175 which is connected with the reference side spindle flange 21 and rotates, the contact portion 176 and the contact portion 177. The contact portion 176 and the contact portion 177 are parallel with the rotation center shaft of the bearing portion 175, and the contact portion 176 is disposed closer to the rotation center shaft of the bearing portion 175 than the contact portion 177.

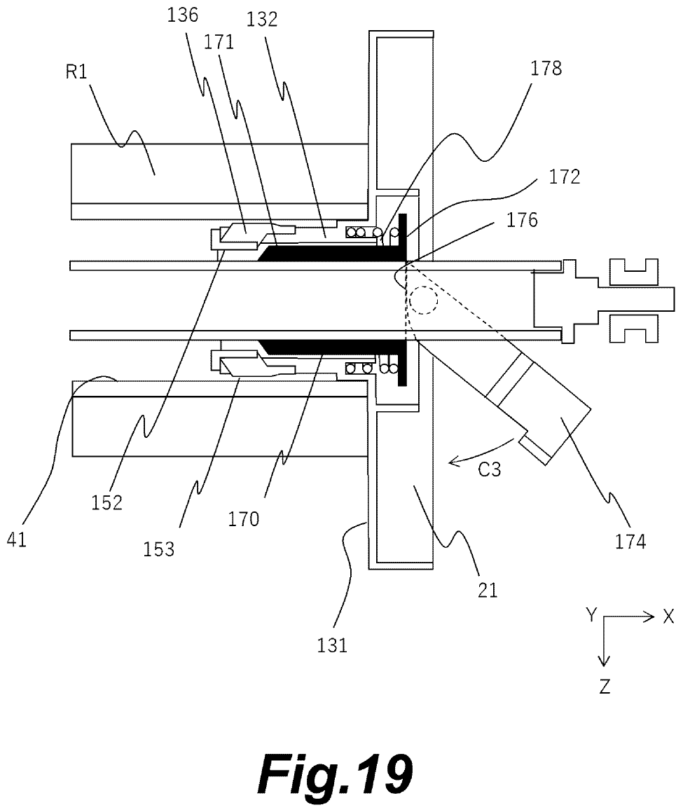

FIG. 19 is a cross-sectional view of the reference side spindle flange 21 sectioned at a plane including the shaft line of the first roll sheet R1 (shaft line of the spindle 19), and indicates the attitude of the first contact portion 136, the linearly moving cam 170, and the grip portion 174 at the first position. At the first position, the pressing portion 171 does not contact the flat portion 152 of the first contact portion 136.

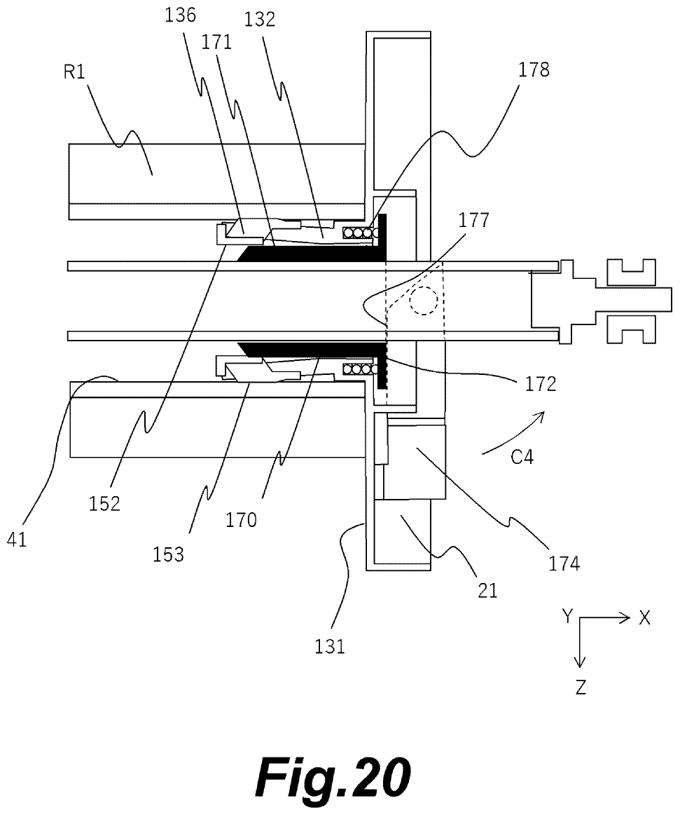

FIG. 20 indicates the attitude of the first contact portion 136, the linearly moving cam 170 and the grip portion 174 at the second position. At the second position, the pressing portion 171 presses the flat portion 152 of the first contact portion 136.

There is a cylindrical-shaped gap between the first contact portion 136 and the linearly moving cam 170, and the compression spring 178 is disposed in this gap. When force is applied from the compression spring 178 in the direction of releasing the compression, the contact portion 176 of the grip portion 174 contacts the flat portion 172 of the linearly moving cam 170 at the first position, and the contact portion 177 of the grip portion 174 contacts the flat portion 172 of the linearly moving cam 170 at the second position.

By rotating the grip portion 174 in the direction of C3 in FIG. 19, the contact position of the grip portion 174 is switched from the contact portion 176 to the contact portion 177. Then the linearly moving cam 170 linearly moves to the left in FIG. 19, and pushes up the first contact portion 136 in the radius direction of the first roll sheet R1, whereby the first position is switched to the second position.

By rotating the grip portion 174 in the direction of C4 in FIG. 20, the contact position of the grip portion 174 is switched from the contact portion 177 to the contact portion 176, then the linearly moving cam 170 linearly moves to the right in FIG. 20, whereby the second position is switched to the first position.

To attach the reference side spindle flange 21 to the first roll sheet R1, the linearly moving cam 170 is switched to the first position, as illustrated in FIG. 19. The reference side flange core 132 is configured so as to not interfere with the first shaft hole 41 of the first roll sheet R1. The interference portion 153 of the first contact portion 136 is also configured so as to not interfere at all or to interfere very little with the first shaft hole 41 of the first roll sheet R1. Therefore, when the reference side spindle flange 21 is attached to the first roll sheet R1, friction between the interference portion 153 and the inner periphery of the first shaft hole 41 of the first roll sheet R1 can be decreased, and operability is improved.

After the reference side spindle flange 21 is inserted into the first roll sheet R1, the linearly moving cam 170 is switched to the second position, as illustrated in FIG. 20. As mentioned above, at the second position, the pressing portion 171 presses the flat portion 152 of the first contact portion 136. Then the interference portion 153 contacts the first shaft hole 41 of the first roll sheet R1, and the reference side spindle flange 21 is fixed to the first shaft hole 41 of the first roll sheet R1.

The inner diameter of the first shaft hole 41 of the first roll sheet R1 varies (large or small inner diameters), depending on the type of sheet, the manufacturing lot, and the like. However, the first contact portion 136 is an elastic body and can be elastically deformed, whereby variations of the inner diameter of the first shaft hole 41 of the first roll sheet R1 can be absorbed, and the reference side spindle flange 21 can be fixed to the first roll sheet R1.

The non-reference side spindle flange 22 also has a configuration similar to the reference side spindle flange 21, and the non-reference side spindle flange 22 is also fixed to the first roll sheet R1. By the above-mentioned procedure, the first roll sheet R1, having the first shaft hole 41 of which inner diameter is 2 inches, can be attached to the roll support member 2.

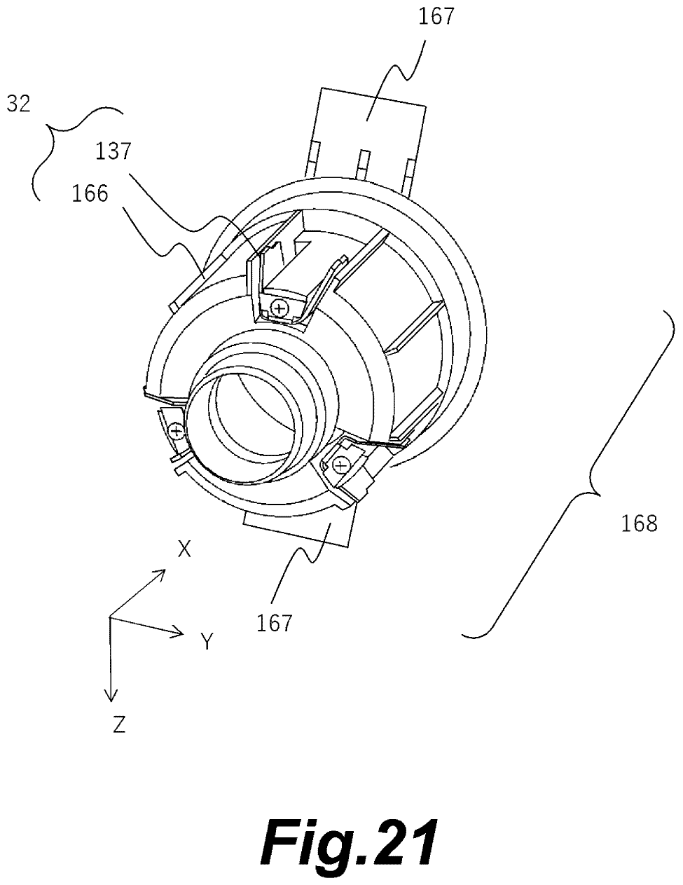

Next, attachment of the second roll sheet R2, having a second shaft hole 42 of which inner diameter is 3 inches (second diameter), will be described. As illustrated in FIG. 21, an attachment member 168 includes the second friction member 32 and the attachment installation portion 167. The second friction member 32 is constituted of an attachment core 166, and a plurality of second contact portions 137, which are disposed symmetrically with respect to the shaft line of the spindle 19.

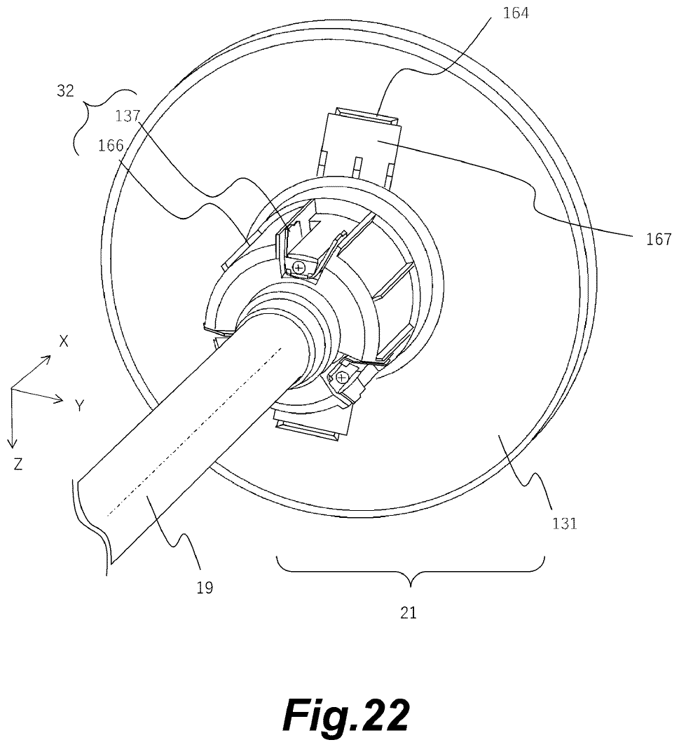

FIG. 22 is an external view of a state where the attachment member 168 is attached to the reference side spindle flange 21. The attachment installation portion 167 is inserted into the attachment installation hole portion 164, and the attachment member 168 is fixed to the reference side spindle flange 21 by a snap-fit type, screw fastening type, or the like. The second contact portion 137 is disposed in the same rotation phase as the opening portion 165 indicated in FIG. 15, with respect to the shaft line of the spindle 19.

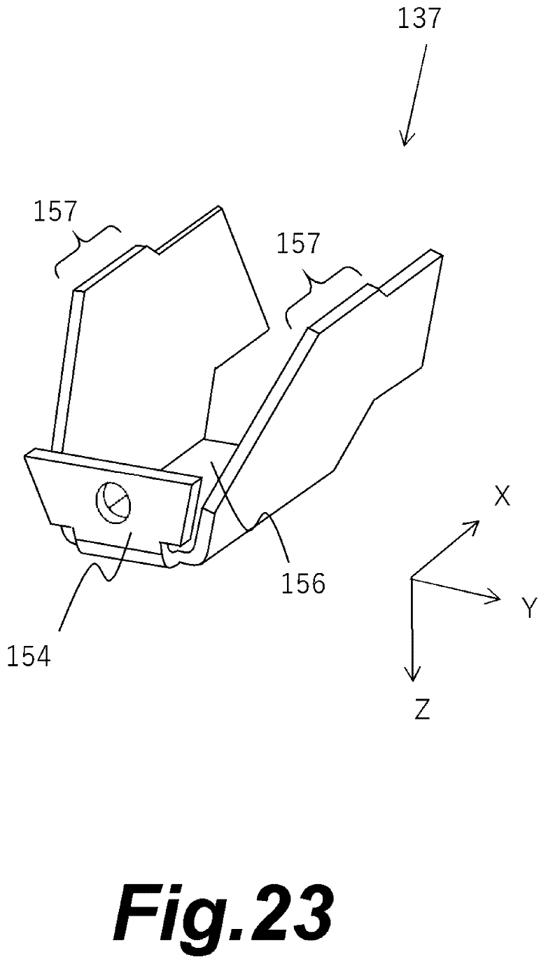

FIG. 23 is an external view of the second contact portion 137. The second contact portion 137 includes the fixing portion 154 which is fixed to the attachment member 168. The second contact portion 137 also includes the flat portion 156, to which the above mentioned second pressing portion 162 is pressed. The second contact portion 137 also includes the interference portion 157 which contacts with the inner periphery of the second shaft hole 42 of the second roll sheet R2. Further, the linearly moving cam 170 is disposed inside the reference side spindle flange 21, and just like the case of the attachment of the 2 inch standard first roll sheet R1, the attitude at the first position illustrated in FIG. 19 and the attitude at the second position illustrated in FIG. 20 can be switched.

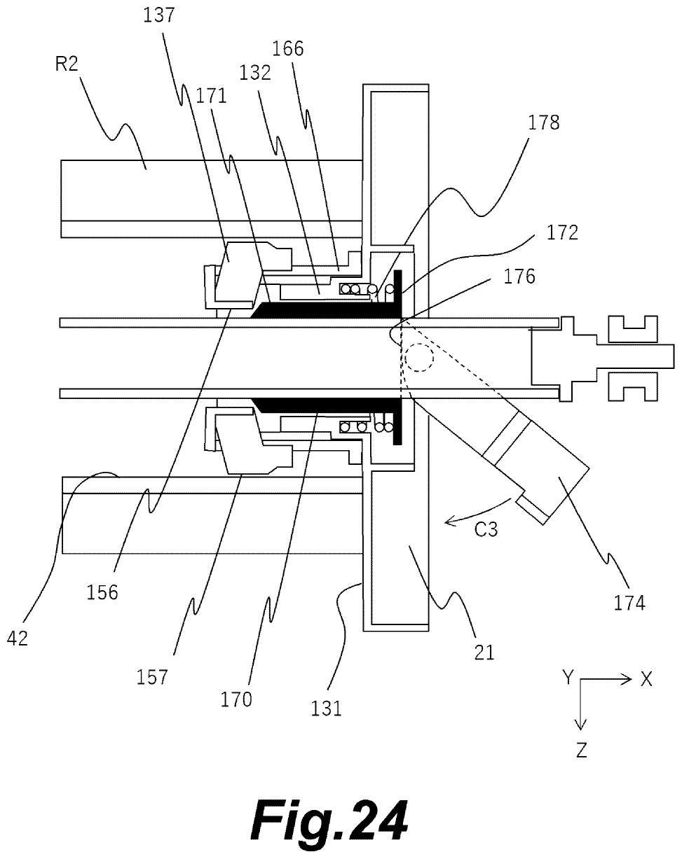

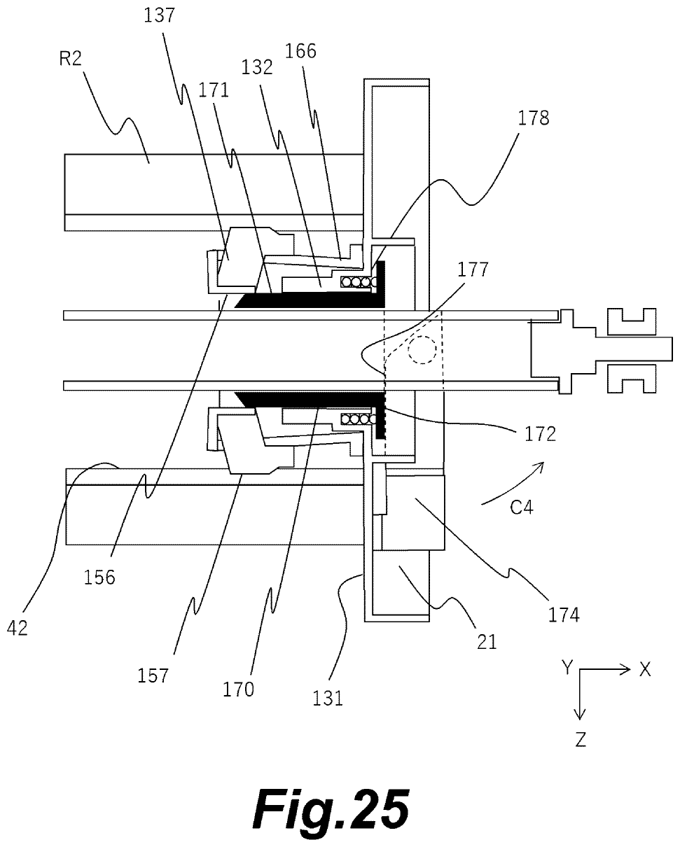

FIGS. 24 and 25 are cross-sectional views of the reference side spindle flange 21 sectioned at a plane including the shaft line of the second roll sheet R2 (shaft line of the spindle 19). FIG. 24 indicates the attitude of the second contact portion 137 and the linearly moving cam 170 at the first position. Ay the first position, the pressing portion 171 and the flat portion 156 of the second contact portion 137 do not contact. FIG. 25 indicates the attitude of the second contact portion 137 and the linearly moving cam 170 at the second position. At the second position, the pressing portion 171 presses the flat portion 156 of the second contact portion 137 through the opening portion 165 disposed in the reference side flange core 132. Just like the case of attaching the 2-inch standard first roll sheet R1, the first position and the second position can be switched by operating the grip portion 174 in the C3 direction in FIG. 24 and the C4 direction in FIG. 25.

To attach the reference side spindle flange 21 to the second roll sheet R2, the linearly moving cam 170 is switched to the first position, as illustrate din FIG. 24. The attachment core 166 is configured so as to not interfere with the second shaft hole 42 of the second roll sheet R2. The interference portion 157 of the second contact portion 137 is also configured so as to not interfere at all or to interfere very little with the second shaft hole 42 of the second roll sheet R2. Therefore, when the reference side spindle flange 21 is attached to the second roll sheet R2, friction between the interference portion 157 and the inner periphery of the second shaft hole 42 of the second roll sheet R2 can be decreased, and operability is improved.

After the reference side spindle flange 21 is inserted into the second roll sheet R2, the linearly moving cam 170 is switched to the second position, as illustrated in FIG. 25. At the second position, the pressing portion 171 presses the flat portion 156 of the second contact portion 137. Then the interference portion 157 contacts the second shaft hole 42 of the second roll sheet R2, and the reference side spindle flange 21 is fixed to the second shaft hole 42 of the second roll sheet R2.

The inner diameter of the second shaft hole 42 of the second roll sheet R2 varies (large or small inner diameters), depending on the type of sheet, the manufacturing lot, and the like. However, the second contact portion 137 is an elastic body and can be elastically deformed, whereby variations of the inner diameter of the second shaft hole 42 of the second roll sheet R2 can be absorbed, and the reference side spindle flange 21 can be fixed to the second roll sheet R2.

The non-reference side spindle flange 22 also has a configuration similar to the reference side spindle flange 21, and the non-reference side spindle flange 22 is also fixed to the second roll sheet R2. By the above-mentioned procedure, the second roll sheet R2, having the second shaft hole 42 of which inner diameter is 3 inches, can be attached to the roll support member 2.

As described above, in Embodiment 2, the linearly moving cam 170 can move between the first position indicated in FIGS. 19 and 24, and the second position indicated in FIGS. 20 and 25. The linearly moving cam 170 includes the pressing portion 171. In the state where the attachment member 168 is not attached to the reference side spindle flange 21, the pressing portion 171 does not contact the first contact portion 136 at the first position. The pressing portion 171 contacts the first contact portion 136 at the second position, and presses the first contact portion 136 radially outward. In the state where the attachment member 168 is attached to the reference side spindle flange 21, the pressing portion 171 does not contact the second contact portion 137 at the first position. The pressing portion 171 contacts the second contact portion 137 in the second position, and presses the second contact portion 137 radially outward.

The pressing portion 171 of the linearly moving cam 170 is an end portion of the cylindrical portion 179, which is coaxial with the spindle 19 and to which the spindle 19 is inserted, and the linearly moving cam 170 can move between the first position and the second position by the cylindrical portion moving in parallel with the axial direction of the spindle 19. The first contact portion 136 and the second contact portion 137 are disposed at different positions (phases) in the circumferential direction of the spindle 19. The first contact portion 136 and the second contact portion 137 are metal leaf springs respectively. The grip portion 174 is an operation member with which the user can perform operation to move the linearly moving cam 170.

In the case of setting the first roll sheet R1 in the roll set portion 200, the reference side flange core 132 is inserted into the first shaft hole 41 in a state where the attachment member 168 is not attached to the reference side spindle flange 21, and the first contact portion 136 is at the first non-pressing position. Then the first contact portion 136 is moved to the first pressing position by the linearly moving cam 170, and the reference side spindle flange 21 is fixed to the first shaft hole 41, whereby the first roll sheet R1 is fixed to the spindle 19.

In the case of setting the second roll sheet R2 in the roll set portion 200, the attachment core 166 is inserted into the second shaft hole 42 in a state where the attachment member 168 is attached to the reference side spindle flange 21, and the second contact portion 137 is at the second non-pressing position. Then the second contact portion 137 is moved to the second pressing position by the linearly moving cam 170, and the attachment member 168 is fixed to the second shaft hole 42, whereby the second roll sheet R2 is fixed to the spindle 19.

The first contact portion 136 moves to the first non-pressing position by moving the linearly moving cam 170 to the first position in the state where the attachment member 168 is not attached to the reference side spindle flange 21. The first contact portion 136 moves to the first pressing position by moving the linearly moving cam 170 to the second position.

The second contact portion 137 moves to the second non-pressing position by moving the linearly moving cam 170 to the first position in a state where the attachment member 168 is attached to the reference side spindle flange 21. The second contact portion 137 moves to the second pressing position by moving the linearly moving cam 170 to the second position.

As described above, in the holding device which can use a plurality of rolled recording media having different inner diameters (e.g. 2 inches, 3 inches), Embodiment 2 allows to decrease the force required to insert or extract the sheet to attach to or detach from the holding device. Thereby operability in the operation to attach or detach the sheet to/from the holding device can be improved.

The first contact portion 136 and the second contact portion 137 are disposed at different rotational phases with respect to the shaft line of the spindle 19. By this disposition, both the first contact portion 136 and the second contact portion 137 can be disposed in positions distant from the reference side flange surface 131. Now a case of creating a small gap between the reference side flange surface 131 and the end portions of the first roll sheet R1 and the second roll sheet R2 in the width direction is considered. In this case, if both the first contact portion 136 and the second contact portion 137 are at positions distant from the reference side flange surface 131, the reference side flange surface 131 and the end portions of the first roll sheet R1 and the second roll sheet R2 in the width direction contact at an inclination smaller than the case of being at positions close to the reference side flange surface 131. Therefore if the first contact portion 136 and the second contact portion 137 are disposed in the positions more distant from the reference side flange surface 131, it can be prevented that the reference side spindle flange 21 inclines from the shaft line of the first shaft hole 41 and the second shaft hole 42 of the first roll sheet R1 and the second roll sheet R2. Based on this relationship, both the first contact portion 136 and the second contact portion 137 are disposed in positions distant from the reference side flange surface 131, whereby inclination of the reference side spindle flange 21 from both the first roll sheet R1 and the second roll sheet R2 can be prevented. This is the same for the non-reference side spindle flange 22.

### Embodiment 3

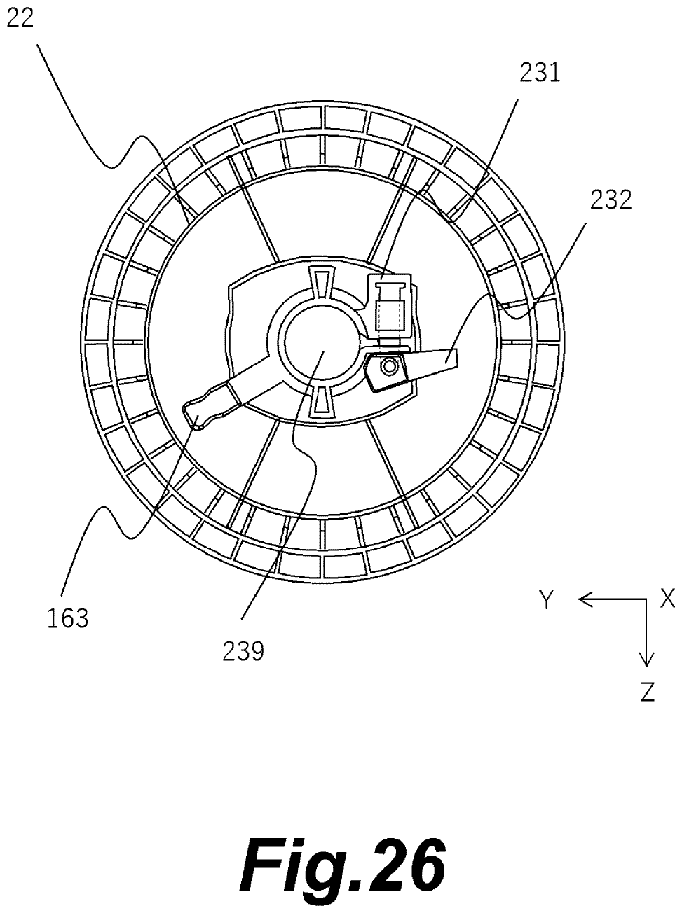

In Embodiment 3, a lock structure to fix the spindle 19 and the non-reference side spindle flange 22 will be described. Further, a lock structure that allows to perform the above fixing operation together with the fixing operation of the non-reference side spindle flange 22 and the roll sheet R, described in Embodiment 1, will be described. FIGS. 26 to 31 are diagrams for describing the non-reference side spindle flange 22 according to Embodiment 3. In the following, differences from Embodiment 1 will be mainly described, and description on the configurations the same as Embodiment 1 will be omitted.

First the structure to lock the non-reference side spindle flange 22 and the spindle 19 will be described with reference to FIGS. 26 to 30.

FIG. 26 is a diagram indicating a spindle lock structure installed in the non-reference side spindle flange 22. In addition to the lock structure of the first shaft hole 41 of the first roll sheet R1 and the reference side spindle flange 21 described in Embodiment 1, Embodiment 3 includes the lock structure of the spindle 19 and the non-reference side spindle flange 22. As illustrated in FIG. 26, the non-reference side spindle flange 22 includes a spindle lock flange 231 and a spindle lock lever 232. By rotating the spindle lock lever 232 clockwise, a later mentioned spindle interference portion 236 is contracted, whereby the spindle 19 is fixed. This lock structure is a structure which is disposed only io the non-reference side spindle flange 22, and is not disposed on the reference side spindle flange 21, which is fixed to the spindle 19 without separation.

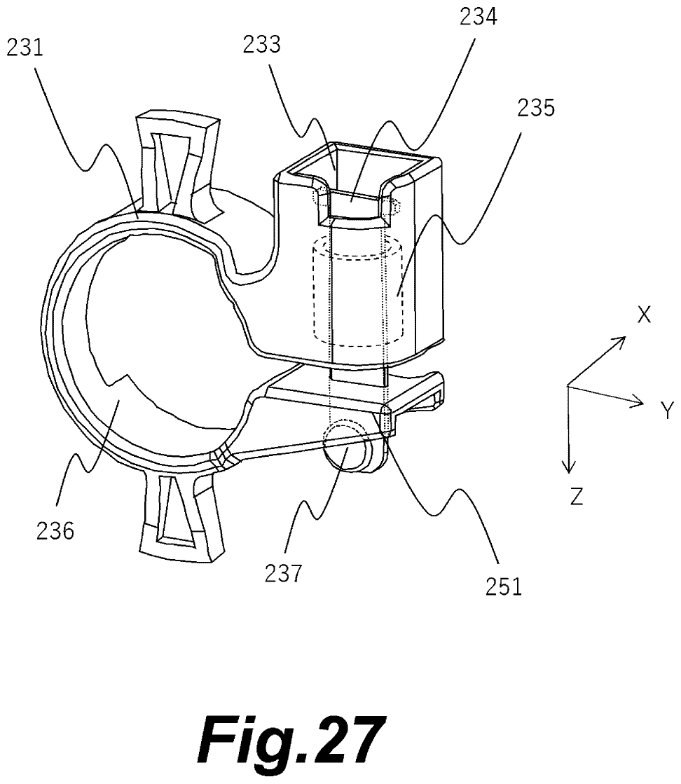

FIG. 27 is an external view of the spindle lock flange 231. The spindle lock flange 231 includes a flange cavity portion 233. In the flange cavity portion 233, a member used for transferring driving to perform locking is housed. The flange cavity portion 233 includes a leaf spring for locking 234, and a spring for locking 235, whereby the force at driving the lever is transferred and a spindle interference portion 236 of the spindle lock flange 231 is contracted, so as to implement the spindle lock. The leaf spring for locking 234 is fixed to the spindle lock lever 232 coaxially through a fixing shaft 237.

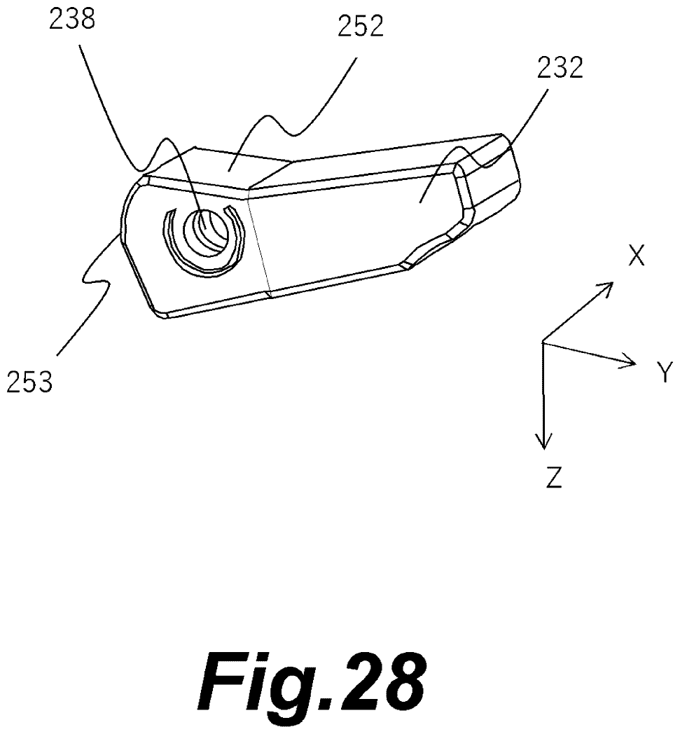

FIG. 28 is an external view of the spindle lock lever 232. The spindle lock lever 232 is fixed to the leaf spring for locking 234 through a fixing shaft installation hole portion 238. The base of the spindle lock lever 232 includes a cam flat portion 252 and a cam curved face portion 253. When the spindle lock lever 232 is rotated around the fixing shaft 237, the cam curved face portion 253 presses the flat portion 251 of the spindle lock flange 231 and creates the locked state.

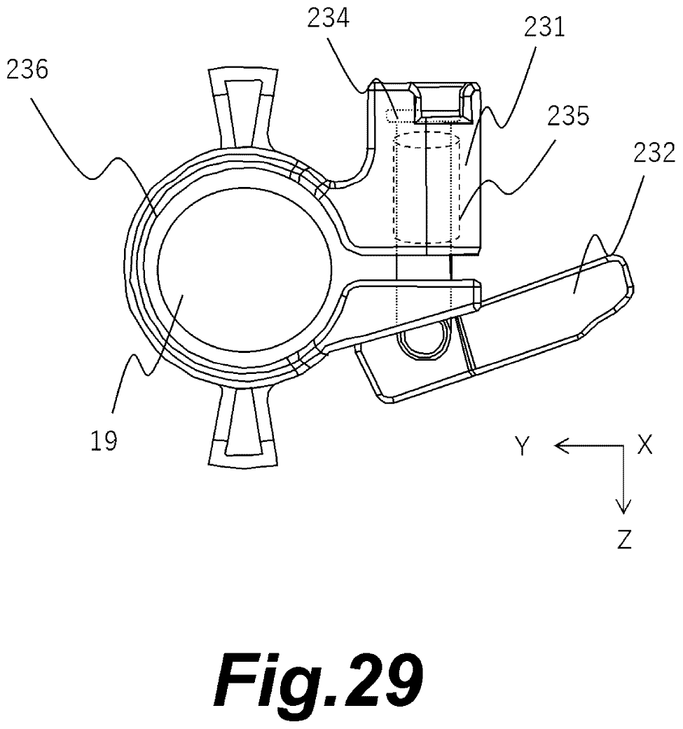

FIG. 29 is an external view of the non-reference side spindle flange 22 in a state where the spindle lock is not performed. In the unlocked state, the base of the spindle lock lever 232 is in a state where the cam flat portion 252 faces a flat portion 251 of the spindle lock flange 231, and the two members do not interfere with each other.

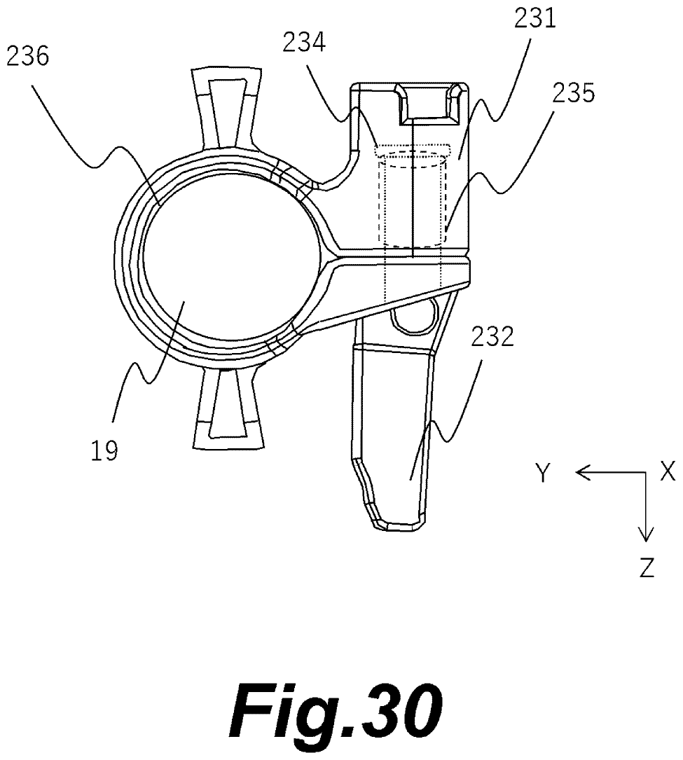

FIG. 30 is an external view of the non-reference side spindle flange 22 in a state where the spindle lock is performed. To perform the spindle lock, the spindle lock lever 232 is rotated clockwise in FIG. 30 around the fixing shaft 237 (rotation shaft), so that the cam curved face portion 253 is pressing the flat portion 251 of the spindle lock flange 231 at the base of the spindle lock lever 232.

To insert the non-reference side spindle flange 22 to the spindle 19, the spindle lock lever 232 is switched to the unlocked state, as illustrated in FIG. 29, and the first roll sheet R1 is attached in this state. After attaching the first roll sheet R1, the non-reference side spindle flange 22 is inserted into the first roll sheet R1, and the spindle lock lever 232 is rotated, as indicated in FIG. 30, to lock the state. This lock structure can function in the same manner even when a 3-inch dedicated attachment member 168 is attached.

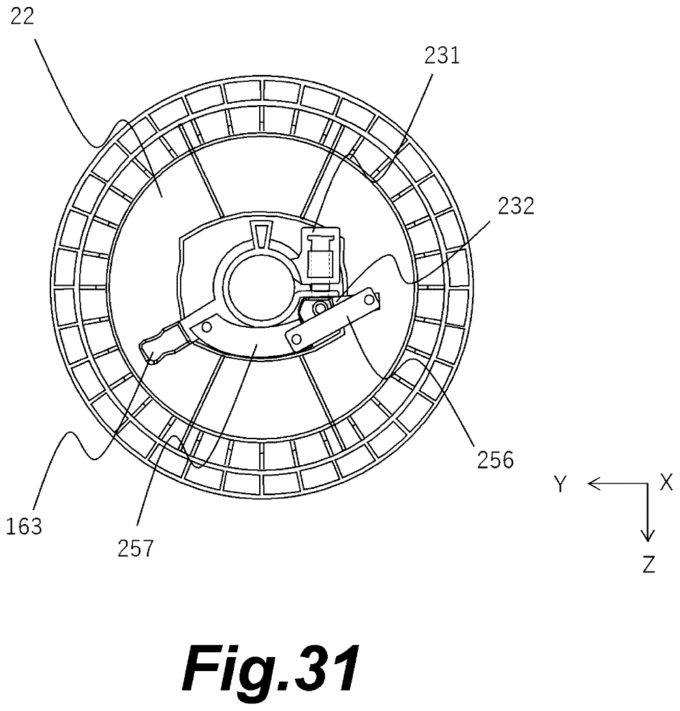

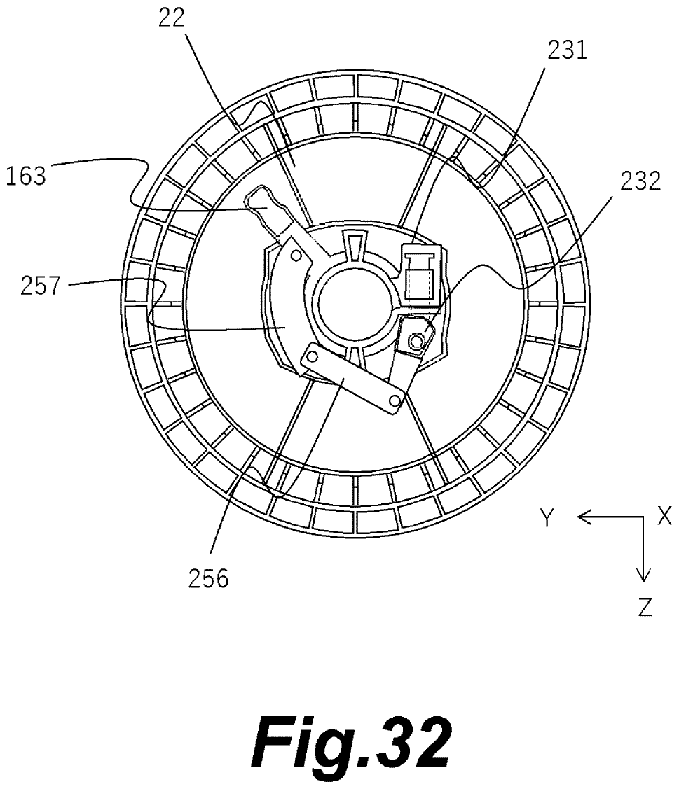

After the non-reference side spindle flange 22 is inserted into the first shaft hole 41 of the first roll sheet R1, the lever portion 163 can be rotated for sheet tube lock, which fixes the non-reference side spindle flange 22 to the first shaft hole 41. Further, the spindle lock lever 232 can be rotated for spindle lock, which fixes the non-reference side spindle flange 22 to the spindle 19. These rotating operations are performed independently from each other. Therefore, to set the first roll sheet R1 in the printer, two lock operations (operation to perform the sheet tube lock by rotating the lever portion 163, and operation to perform the spindle lock by rotating the spindle lock level 232) are required. To prevent this, a configuration to perform both the sheet tube lock and the spindle lock simultaneously by performing only one of the sheet tube lock and the spindle lock will be described with reference to FIGS. 31 and 32.

The lever portion 163 and the spindle lock lever 232 are connected with an intermediate link 256 and an intermediate link 257, and the lever portion 163 is rotated from a first position to a second position in this state. At this time, rotational driving is also transferred to the spindle lock lever 232, whereby the sheet tube lock and the spindle lock can be performed simultaneously.

FIG. 31 is a diagram indicating the non-reference side spindle flange 22 in a case where both the sheet tube and the spindle are in the unlocked state. FIG. 32 is a diagram indicating the non-reference side spindle flange 22 in a case where both the sheet tube and the spindle are in the locked state. If the lever portion 163 is rotated clockwise in FIG. 31, the rotational driving is transferred to the spindle lock lever 232 via the intermediate link 256 and the intermediate link 257, whereby the spindle lock lever 232 is also rotated clockwise. In this example, the linking is the mechanism to transfer the driving acting on the lever portion 163 to the spindle lock lever 232, but the transfer member may be constituted of a gear, a cam or the like. The sheet tube lock is not limited to the operation to rotate the lever portion 163, but may be a configuration where such a lock mechanism as the grip portion 174 interlocks with the spindle lock lever 232, for example. In this way, by implementing a configuration in which two locks are established simultaneously with one operation, the user operation to set the first roll sheet R1 is simplified. The above description is also applicable to the setting of the second roll sheet R2.

As described above, in Embodiment 3, the non-reference side spindle flange 22 (first fixing member), to fix the roll sheet R to the spindle 19, has a through hole 293 to which the spindle 19 is inserted. The spindle lock flange 231, the spindle lock lever 232 and the spindle interference portion 236 constitutes a fastening portion which radially fastens the spindle 19 inserted into the through hole 293 so that the fastening portion is able to fix the non-reference side spindle flange 22 to the spindle 19. In a state where the attachment member 168 is not attached to the reference side spindle flange 21, the lever portion 163 can be operated to move the rotating cam 160 from the first non-pressing position to the first pressing position (a first operation). Further, in a state where the attachment member 168 is attached to the reference side spindle flange 21, the lever portion 163 can be operated to move the rotating cam 160 from the second non-pressing position to the second pressing position (a second operation). The intermediate links 256 and 257 are mechanisms to interlock the first and second operations with an action of fastening the spindle 19 by the fastening portion.

According to the present disclosure, in the recording device having the holding device which can support roll sheets of which inner diameters of the respective shaft holes are different, operability of the attachment/detachment of the roll sheet to/from the holding device can be improved.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-033235, filed on Mar. 5, 2024, which is hereby incorporated by reference herein in its entirety.

What is claimed is:

1. A recording device, comprising:
a holding device configured to hold a roll sheet that is a sheet rolled around a shaft having a shaft hole; and
a recording unit configured to perform recording on the sheet supplied from the roll sheet held by the holding device, wherein
the holding device further comprising:
a first fixing member including a first core configured to be inserted into a first shaft hole of a first roll sheet, the first shaft hole having a first inner diameter;
a first contact portion formed of an elastic body disposed in the first fixing member, the first contact portion being configured to move between a first pressing position where the first contact portion contacts an inner peripheral surface of the first shaft hole and presses the inner peripheral surface radially outward and a first non-pressing position located on a radially inward side of the first pressing position;
a cam configured to move the first contact portion between the first pressing position and the first non-pressing position;
a second fixing member configured to be attached to or detached from the first fixing member, the second fixing member including a second core configured to be inserted into a second shaft hole of a second roll sheet, the second shaft hole having a second inner diameter larger than the first inner diameter; and
a second contact portion formed of an elastic body disposed in the second fixing member, the second contact portion being configured to move between a second pressing position where the second contact portion contacts an inner peripheral surface of the second shaft hole and presses the second shaft hole radially outward and a second non-pressing position located on a radially inward side of the second pressing position, wherein
in a state where the second fixing member is attached to the first fixing member, the cam moves the second contact portion between the second pressing position and the second non-pressing position.

2. The recording device according to claim 1, wherein
the recording unit is configured to perform recording on a first sheet supplied from the first roll sheet, into the first shaft hole of which the first core of the first fixing member is inserted.

3. The recording device according to claim 1, wherein
the recording unit is configured to perform recording on a second sheet supplied from the second roll sheet, into the second shaft hole of which the second core of the second fixing member is inserted.

4. The recording device according to claim 1, wherein
the recording unit performs recording on a sheet by ejecting ink.

5. The recording device according to claim 1, wherein
the cam is configured to move between a first position and a second position, and
the cam includes:
a first pressing portion configured not to contact the first contact portion at the first position and to contact the first contact portion and press the first contact portion radially outward at the second position, in a state where the second fixing member is not attached to the first fixing member; and
a second pressing portion configured not to contact the second contact portion at the first position and to contact the second contact portion and press the second contact portion radially outward at the second position, in a state where the second fixing member is attached to the first fixing member.

6. The recording device according to claim 5, wherein
the recording device includes:
a shaft member configured to be inserted into the shaft hole of the roll sheet; and
bearings configured to support both ends of the shaft member, wherein
the cam includes a cylindrical portion to which the shaft member is inserted and which is coaxial with the shaft member, and
the cam is configured to move between the first position and the second position by the cylindrical portion rotating around the shaft member.

7. The recording device according to claim 6, wherein
the first contact portion and the second contact portion are disposed at different positions in an axial direction of the shaft member, and
the first pressing portion and the second pressing portion are disposed at positions corresponding to the first contact portion and the second contact portion respectively in the axial direction of the cylindrical portion.

8. The recording device according to claim 7, wherein
the second contact portion is disposed at a position closer to the center of the shaft member than the first contact portion in the axial direction.

9. The recording device according to claim 6, wherein
the first contact portion and the second contact portion are disposed at the same position in a circumferential direction of the shaft member.

10. The recording device according to claim 1, wherein
the cam is configured to move between a first position and a second position,
the cam includes a pressing portion,
the pressing portion is configured not to contact the first contact portion at the first position and to contact the first contact portion and press the first contact portion radially outward at the second position, in a state where the second fixing member is not attached to the first fixing member, and
the pressing portion is configured not to contact the second contact portion in the first position and to contact the second contact portion and press the second contact portion radially outward at the second position, in a state where the second fixing member is attached to the first fixing member.

11. The recording device according to claim 10, wherein
the recording device includes:
a shaft member configured to be inserted into the shaft hole of the roll sheet; and
bearings configured to support both ends of the shaft member, wherein
the cam includes a cylindrical portion to which the shaft member is inserted and which is coaxial with the shaft member, and
the cam is configured to move between the first position and the second position by the cylindrical portion moving parallel with the axial direction of the shaft member.

12. The recording device according to claim 11, wherein
the first contact portion and the second contact portion are disposed at different positions in a circumferential direction of the shaft member, and
the pressing portion is an end portion of the cylindrical portion in the axial direction.

13. The recording device according to claim 1, wherein
the first contact portion and the second contact portion are metal leaf springs respectively.

14. The recording device according to claim 1, further comprising an operation member with which a user performs operation to move the cam.

15. The recording device according to claim 14, wherein
the recording device includes:
a shaft member configured to be inserted into the shaft hole of the roll sheet; and
bearings configured to support both ends of the shaft member, wherein
the first fixing member includes:
a through hole through which the shaft member is inserted; and
a fastening portion configured to fix the first fixing member to the shaft member by radially fastening the shaft member inserted in the through hole, wherein
the recording device includes a mechanism configured to interlock first and second operations of the operation member with an action of fastening the shaft member by the fastening portion, the first operation being an operation of the operation member for moving the cam from the first non-pressing position to the first pressing position in a state where the second fixing member is not attached to the first fixing member, and the second operation being an operation of the operation member for moving the cam from the second non-pressing position to the second pressing position in a state where the second fixing member is attached to the first fixing member.
